(19) United States
(12) Patent Application Publication
(10) Pub. No.: US 2025/0231979 A1
(43) Pub. Date: Jul. 17, 2025

(54) SYSTEMS AND METHODS FOR PROVIDING PERSONALIZED SECURITY INFORMATION BASED ON USER INTERACTIONS

(71) Applicant: Sysnet North America, Inc., Chicago, IL (US)

(72) Inventors: Thomas Joseph Patterson, Sumter, SC (US); Tyler Leslie Owen, Mechanicsville, VA (US); James Kevin Pierce, Raleigh, NC (US)

(21) Appl. No.: 19/022,379

(22) Filed: Jan. 15, 2025

Related U.S. Application Data
(60) Provisional application No. 63/620,977, filed on Jan. 15, 2024.

(51) Int. Cl. G06F 16/335; G06F 21/57

(52) U.S. Cl. CPC G06F 16/337; G06F 21/577; G06F 2221/034

(57) ABSTRACT

Various methods, systems, and computer program products are provided for providing personalized security information based on prompt responses. A method may include receiving a first query from a computing device associated with an account. The first query includes one or more words that are related to the account. The method may also include determining an account knowledge level for the account based on at least one of the one or more words of the first query, wherein the account knowledge level indicates a sophistication of the account. The method may further include determining a first response to the first query based on the account knowledge level associated with the account. A response complexity level of one or more words used in the first response are based on the account knowledge level.

### CROSS-REFERENCE TO RELATED APPLICATIONS

The present application claims priority to U.S. Patent Application No. 63/620,977, titled SYSTEMS AND METHODS FOR PROVIDING PERSONALIZED SECURITY INFORMATION BASED ON USER INTERACTIONS, filed on Jan. 15, 2024, the contents of which are hereby incorporated in their entirety.

### FIELD

An example embodiment relates generally to processing security data, and more particularly, to providing personalized security information based on user interactions.

### BACKGROUND

Users of varying degrees of sophistication are required to meet certain security standards and compliance. However, it can be difficult for a user to process large amounts of data from different sources in order to quickly and efficiently monitor security threats and/or standards. Additionally, products that assist users with security and compliance information are one-size-fits-all, even with the varying levels of sophistications. As such, there exists a need for a system that can provide personalized security information based on user interactions.

### SUMMARY

The following paragraphs present a summary of various embodiments of the present disclosure and are merely examples of potential embodiments. As such, the summary is not meant to limit the subject matter or variations of various embodiments discussed herein.

In an example embodiment, a method for providing personalized security information based on prompt responses is provided. The method includes receiving a first query from a computing device associated with an account. The first query includes one or more words that are related to the account. The method also includes determining an account knowledge level for the account based on at least one of the one or more words of the first query. The account knowledge level indicates a sophistication of the account. The method further includes determining a first response to the first query based on the account knowledge level associated with the account. A response complexity level of one or more words used in the first response are based on the account knowledge level.

In various embodiments, the method also includes receiving an account history indicator with the account history indicator including one or more pages accessed by the account, and updating the account knowledge level based on the account history indicator.

In various embodiments, each of the one or more pages are assigned a complexity level with a higher complexity level indicating that the account knowledge level is higher.

In various embodiments, the method also includes updating the account knowledge level for the account based on a second query.

In various embodiments, the account knowledge level is determined to be one of a plurality of account knowledge levels, wherein a first account knowledge level is higher than a second account knowledge level.

In various embodiments, the first response is different in an instance in which the account knowledge level for the account is the first account knowledge level than in an instance in which the account knowledge level for the account is the second account knowledge level.

In various embodiments, the method also includes assigning a base account knowledge level for the account in an instance the first query has not been received.

In various embodiments, determining the account knowledge level for the account based on at least one of the one or more words of the first query includes updating the base account knowledge level based on the at least one of the one or more words of the first query.

In various embodiments, the method also includes causing the first response to be provided to the computing device associated with the account.

In another example embodiment, a system for providing personalized security information based on prompt responses is provided. The system includes at least one non-transitory storage device; and at least one processing device coupled to the at least one non-transitory storage device. The at least one processing device is configured to receive a first query from a computing device associated with an account. The first query includes one or more words that are related to the account. The at least one processing device is also configured to determine an account knowledge level for the account based on at least one of the one or more words of the first query. The account knowledge level indicates a sophistication of the account. The at least one processing device is further configured to determine a first response to the first query based on the account knowledge level associated with the account. A response complexity level of one or more words used in the first response are based on the account knowledge level.

In various embodiments, the at least one processing device is further configured to receive an account history indicator with the account history indicator including one or more pages accessed by the account, and update the account knowledge level based on the account history indicator.

In various embodiments, each of the one or more pages are assigned a complexity level with a higher complexity level indicating that the account knowledge level is higher.

In various embodiments, the at least one processing device is further configured to update the account knowledge level for the account based on a second query.

In various embodiments, the account knowledge level is determined to be one of a plurality of account knowledge levels, wherein a first account knowledge level is higher than a second account knowledge level.

In various embodiments, the first response is different in an instance in which the account knowledge level for the account is the first account knowledge level than in an instance in which the account knowledge level for the account is the second account knowledge level.

In various embodiments, the at least one processing device is further configured to assign a base account knowledge level for the account in an instance the first query has not been received.

In various embodiments, determining the account knowledge level for the account based on at least one of the one or more words of the first query includes updating the base account knowledge level based on the at least one of the one or more words of the first query.

In various embodiments, the at least one processing device is further configured to cause the first response to be provided to the computing device associated with the account.

In still another example embodiment, a computer program product for providing personalized security information based on prompt responses is provided. The computer program product including at least one non-transitory computer-readable medium having one or more computer-readable program code portions embodied therein, the one or more computer-readable program code portions including at least one executable portion configured to receive a first query from a computing device associated with an account. The first query includes one or more words that are related to the account. The at least one executable portion also configured to determine an account knowledge level for the account based on at least one of the one or more words of the first query. The account knowledge level indicates a sophistication of the account. The at least one executable portion further configured to determine a first response to the first query based on the account knowledge level associated with the account, wherein a response complexity level of one or more words used in the first response are based on the account knowledge level.

In various embodiments, the one or more computer-readable program code portions include at least one executable portion further configured to: receive an account history indicator, wherein the account history indicator includes one or more pages accessed by the account; and update the account knowledge level based on the account history indicator.

In various embodiments, each of the one or more pages are assigned a complexity level, wherein a higher complexity level indicates that the account knowledge level is higher.

In various embodiments, the one or more computer-readable program code portions include at least one executable portion further configured to update the account knowledge level for the account based on a second query.

In various embodiments, the account knowledge level is determined to be one of a plurality of account knowledge levels, wherein a first account knowledge level is higher than a second account knowledge level.

In various embodiments, the first response is different in an instance in which the account knowledge level for the account is the first account knowledge level than in an instance in which the account knowledge level for the account is the second account knowledge level.

In various embodiments, the one or more computer-readable program code portions include at least one executable portion further configured to assign a base account knowledge level for the account in an instance the first query has not been received.

In various embodiments, determining the account knowledge level for the account based on at least one of the one or more words of the first query includes updating the base account knowledge level based on the at least one of the one or more words of the first query.

In various embodiments, the one or more computer-readable program code portions include at least one executable portion further configured to cause the first response to be provided to the computing device associated with the account.

Implementation of the method and/or system of embodiments of the present disclosure can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. The memory device(s) discussed herein may include at least one non-transitory storage device. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Many aspects of the present disclosure will be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views. It should be recognized that these implementations and embodiments are merely illustrative of the principles of the present disclosure. Therefore, in the drawings:

FIG. 1 provides a block diagram illustrating a system environment for dynamically determining a response to a query, in accordance with various embodiments of the present disclosure;

FIG. 2 provides a block diagram illustrating the text server 151 of FIG. 1, in accordance with various embodiments of the present disclosure;

FIG. 3 provides a block diagram illustrating the response determination server 157 of FIG. 1, in accordance with various embodiments of the present disclosure;

FIG. 4 provides a block diagram illustrating the computing device 152 of FIG. 1, in accordance with various embodiments of the present disclosure;

FIG. 5 provides an example diagram illustrating the architecture used to process compliance data and security data to generate a response to a query, in accordance with various embodiments of the present disclosure;

FIG. 6 is a flowchart 600 is provided illustrating the high-level processing of the determining a response to a query, in accordance with various embodiments of the present disclosure;

FIGS. 7A-7C provide example user interfaces with conversations between a user and the system, in accordance with various embodiments of the present disclosure;

FIG. 8 provides a block diagram illustrating example processing upon receiving a query, in accordance with various embodiments of the present disclosure;

FIG. 9 provides another block diagram illustrating the processing operations of determining a response to a query, in accordance with various embodiments of the present disclosure;

FIG. 10 is a flowchart 1000 illustrating an example operation of determining a response to a query, in accordance with various embodiments of the present disclosure;

FIG. 11 is a flowchart 1100 illustrating a method of determining a response to a query, in accordance with various embodiments of the present disclosure;

FIG. 12 is a flowchart 1200 illustrating a method of determining additional responses to additional queries, in accordance with various embodiments of the present disclosure;

FIG. 13 is a flowchart 1300 illustrating a method of generating one or more of the data packet(s), in accordance with various embodiments of the present disclosure;

FIG. 14 is a flowchart 1400 illustrating a method for providing personalized security information based on prompt responses, in accordance with various embodiments of the present disclosure; and

FIG. 15 is a diagram 1500 is shown illustrating how the personalized user experience is determined and how the user experience is changed based on the account knowledge level of an account, in accordance with various embodiments of the present disclosure.

### DETAILED DESCRIPTION

The presently disclosed subject matter now will be described more fully hereinafter with reference to the accompanying drawings, in which some, but not all embodiments of the presently disclosed subject matter are shown. Like numbers refer to like elements throughout. The presently disclosed subject matter may be embodied in many different forms and should not be construed as limited to the embodiments set forth herein; rather, these embodiments are provided so that this disclosure will satisfy applicable legal requirements.

Indeed, many modifications and other embodiments of the presently disclosed subject matter set forth herein will come to mind to one skilled in the art to which the presently disclosed subject matter pertains having the benefit of the teachings presented in the foregoing descriptions and the associated drawings. Therefore, it is to be understood that the presently disclosed subject matter is not to be limited to the specific embodiments disclosed and that modifications and other embodiments are intended to be included within the scope of the appended claims.

Throughout this specification and the claims, the terms “comprise,” “comprises”, and “comprising” are used in a non-exclusive sense, except where the context requires otherwise. Likewise, the term “includes” and its grammatical variants are intended to be non-limiting, such that recitation of items in a list is not to the exclusion of other like items that can be substituted or added to the listed items.

### I. Example Use Case

Systems designed to identify cyber-security threats generally gather large volumes of data from numerous data sources, including network traffic data, logs (systems, applications, security devices, cloud resources), threat intelligence feeds, endpoint data, user behavior analysis, file integrity monitoring, vulnerability scans, and dark web monitoring tools. Data gathered from these sources is generally called “Security Data” and may be stored in one or more security databases.

Data may also be gathered related to compliance, which is typically generated based on user responses to questions. For example, an account may be asked to provide general information relating to cybersecurity, such as number of nodes (e.g., computing devices) on a system, type of security currently implemented, qualified employees, etc. As such, the “compliance data” may be stored in one or more compliance databases. Typically, compliance data and security data are stored by different entities, making it difficult to use both types of data to provide answers to account queries.

Organizations employ numerous processes and tools to handle the large volume of security data and to segment data representing validated security threats from data that is simply a part of normal operations. Tools and applications like Security Information and Event Management (SIEM) solutions, combined with trained security analysts, review and validate data that is thought to be a security threat.

Artificial intelligence (AI) and machine learning (ML) tools are increasingly used in analyzing these large volumes of security data; however, AI and ML tools, like all other tools and analysis efforts, are only as good as the data collected. Increased performance in determining security threats can be achieved by augmenting the security data collected with data derived from human-evaluated compliance and security assessments.

Various embodiments of the present disclosure provide for automated responses to queries by a user. To do this, a user may submit a query to an automated chat feature. The system of various embodiments may then use both security data discussed above along with compliance data (e.g., compliance data from one or more compliance databases may include data provided by an account relating to compliance and/or information determined by the system relating to the account) to determine a response to the query. The response may include providing information relating to an account, such as statistics, simulated test results, and/or the like. The queries and responses may be provided to a user interface for a user associated to an account in a conversational format (e.g., a textual conversation between the system and the user associated with the account).

In some aspects, the techniques described herein relate to a method for dynamically determining a response to a query. The determination of a response to a query is capable of being dynamic due to the processing of data packet(s) from data sources. The method includes receiving a first query from a computing device associated with an account with first query including a request for information relating to the account; determining, based on the first query, at least one of a security database or a compliance database that contains one or more data packets relating to the first query and the account; receiving, from the at least one of the security database or the compliance database, the one or more data packets relating to the first query and the account; determining a first response to the first query based on the one or more data packets relating to the first query and the account; and causing the first response to be provided to the computing device associated with the account.

In some aspects, the techniques described herein relate to a method, further including determining the potential test to simulate based on the first query.

In some aspects, the techniques described herein relate to a method, wherein the first query and the first response are rendered to the user interface in a conversation format.

In various embodiments, systems and/or computer program products may be provided configured to carry out the operations of the method discussed herein.

Additionally, varying levels of understanding of subject matter can increase call volumes, support requests, disinterest in product, and/or lack of use of a system. Users of security and compliance products have an incredibly wide and varying degree of understanding of the security and compliance issues which can be displayed by a security or compliance product. For example, users in small organizations may have no or minimal understanding of cyber security issues, and therefore require product output specifically tailored to their knowledge level. Specifically, users who are mandated by a compliance, regulation, or security interest will procure products that are oftentimes difficult to understand. Thus, resulting in users who are significantly withdrawn from the process of their security and/or compliance.

Various embodiments of the present disclosure provide for a dynamic user experience that adapts based on the knowledge level of a user and/or entity. As such, the present disclosure uses intent-based prompting by level of an account's (user level and/or entity level) understanding of the subject matter being displayed on screen. By understanding the user's level of understanding of items displayed via metrics such as times a user accesses support articles, submissions for support, lexicon used in communications, the system can discern the level of user understanding. From the determination of account knowledge level, intent-based prompting can modify nomenclature, vernacular, and/or communication with user to a level aligned with the user's knowledge. As the user interacts with the software, support, and personnel of the product the system can discern with higher certainty the level of understanding and adjust to ensure it stays within the user's realm of Compliance and security platforms and products either provide a standard user vernacular, nomenclature, and level of communication for user interactions, or at most some systems may allow users to select a specific persona and adjust vernacular, nomenclature and level of communication based on user selection.

In an example use case, systems and/or methods discussed herein may be used by merchants. Namely, systems and/or methods may use security data and/or compliance data to answer queries associated with a merchant. In various embodiments, the knowledge level of the user and/or entity may be used to determine the information provided. As such, the account knowledge level for a merchant may accept parameters that are based on the size of the merchant, the type of industry the merchant is in, the amount of training related to cybersecurity, the length the merchant has been in business and available through the Internet, whether the merchant is business to business or business to consumer, other example parameters include backgrounds of the business principles, type of products or services being offered, and other qualities. The system may determine a base account knowledge level and update the account knowledge level based on actions of the merchants (e.g., based on queries from the merchant, actions from the merchant, and years without a cyber issue, to name a few). The account knowledge level for an account and/or entity (e.g., such as a merchant) may be used to determine responses to the merchant, allowing for targeted responses that the merchant is capable of understanding.

### II. With Reference to the Figs

Reference will now be made in detail to aspects of the disclosure, examples of which are illustrated in the accompanying drawings. The following description refers to the accompanying drawings in which the same numbers in different drawings represent the same or similar elements unless otherwise represented. The implementations set forth in the following description do not represent all implementations consistent with the disclosure. Instead, they are merely examples of apparatuses and methods consistent with aspects related to the disclosure as recited in the appended claims. Particular aspects of the present disclosure are described in greater detail below. The terms and definitions provided herein control, if in conflict with terms and/or definitions incorporated by reference.

Systems, methods, and apparatuses are described herein which relate generally to dynamically determining security status and/or predicted outcomes via prompt-based communications with a user. In the following description, for purposes of explanation, numerous specific details are set forth to provide a thorough understanding of the present disclosure. It will be evident, however, to one skilled in the art that the present disclosure may be practiced without these specific details and/or with any combination of these details.

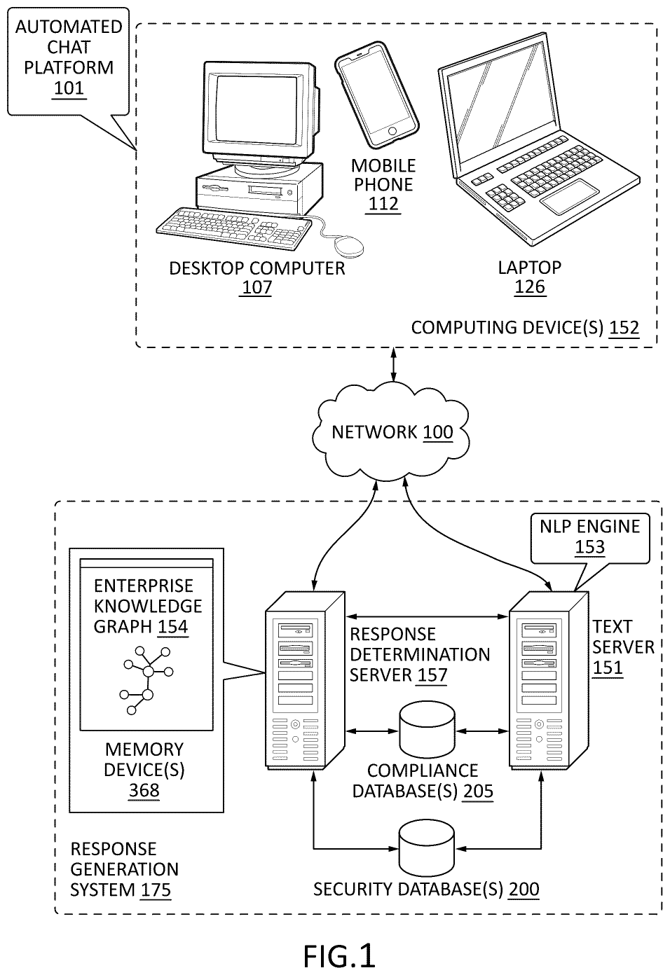

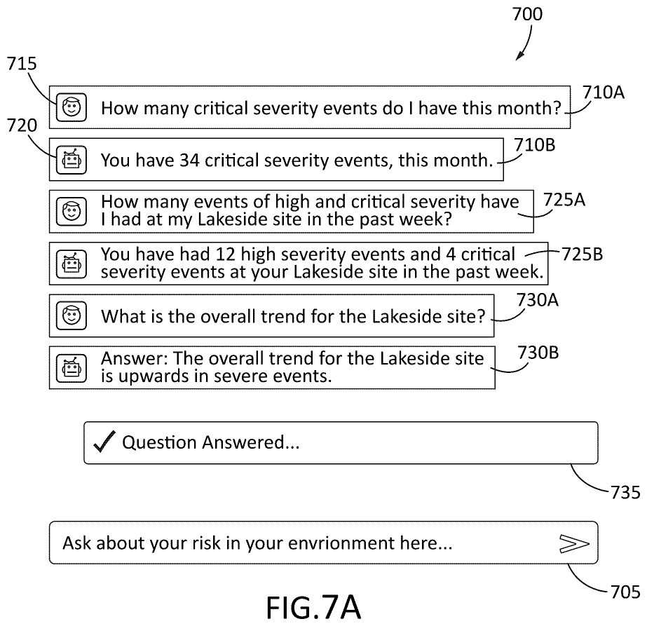

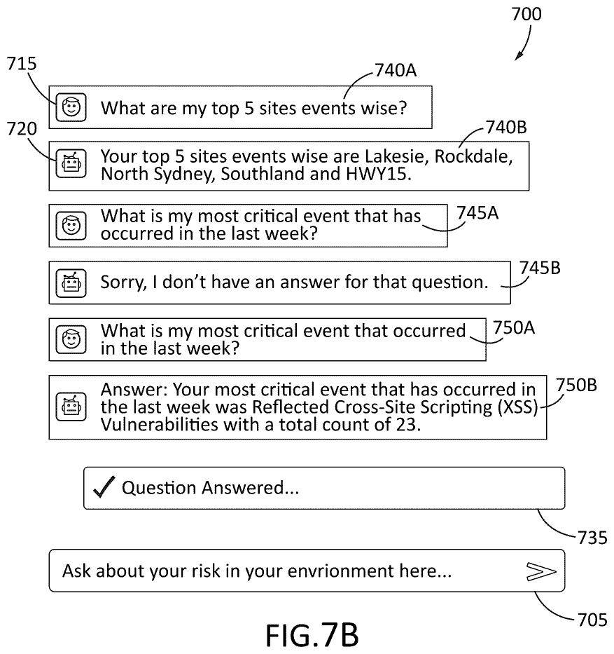

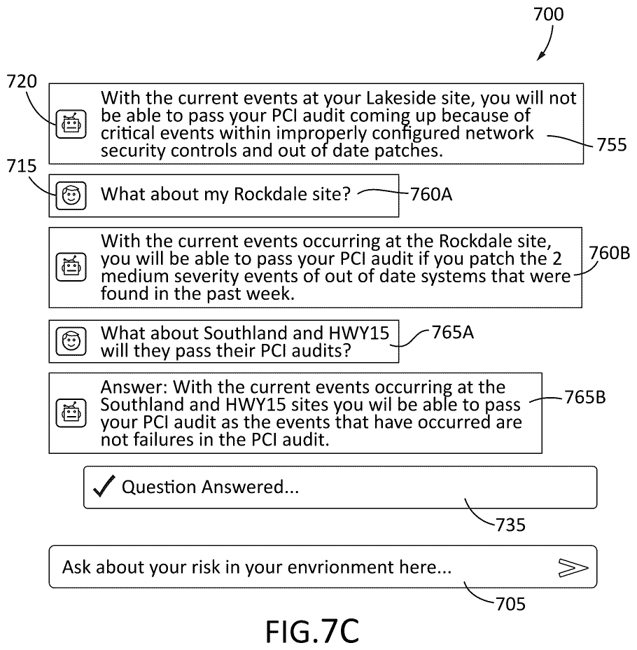

Referring now to FIG. 1, a block diagram illustrating a system environment (“system”) for determining a response to a query, in accordance with various embodiments is provided. The system includes computing device(s) 152 and a response generation system 175 connected to a network 100. As shown, the computing device(s) 152 (e.g., desktop computer 107, mobile phone 112, laptop 126, and/or the like) associated with users are in communication with network 100. The computing device(s) 152 each interact with an automated chat platform 101, such in FIGS. 7A-7C. A Response generation system 175 is also in communication with the network 100. The response generation system 175 comprises a text server 151 and a response determination server 157. In various embodiments, each of the text server 151 and a response determination server 157 may be made of multiple servers. In various embodiments, the text server 151 and a response determination server 157 may be combined into a single server or group of servers.

As shown, the response determination server 157 may have memory device(s) 368 which include an enterprise knowledge graph 154 used in various embodiments herein. As such, the response determination server 157 may use nearest node functions to process queries and determine responses to said queries. An enterprise knowledge graph, as used herein comprises interconnected data of a particular organization or organizations, and provides a unified view of data across various domains. Key characteristics include interconnected data (objects and their relationships), semantic context (metadata and ontologies), unified view (disparate sources of data), and scalability. Core components include nodes and edges, ontologies and taxonomies, data sources, inference engines, and interfaces.

The graph database of FIG. 1 is a semantic graph database and stored within the graph database is an enterprise knowledge graph 154. The example enterprise knowledge graph of FIG. 1 may be implemented, for example, according to the Resource Description Framework (‘RDF’). In such an implementation, the enterprise knowledge graph has each data item represented by a resource identifier. Such resource identifiers may include a uniform resource identifier (‘URI’), an internationalized resource identifier (‘IRI’), a uniform resource locator (‘URL’), a literal, a non-literal, and/or any other resource identifier. RDF makes resource identifier relationships between data items the central attribute of the overall data model. Resource identifiers, such as URIs, are created with data and linked together using relationships that are also named with resource identifiers. The fact that all identifiers in an RDF data store are named with identifiers means that all data items, including relationship, edges, or properties, are expressly defined and self-defined.

The enterprise knowledge graph 154 of FIG. 1 has characteristics of mathematical directed graphs in that it is composed of vertices (a.k.a. nodes) and directed edges. Each edge connects two vertices, has a type, and can have one or more properties. Each property in this example may be implemented as a key-value pair. The ability to characterize an edge and attach properties to it increases the semantic expressiveness of such a knowledge graph. This description of graph databases and semantic graph databases is for explanation and not for limitation. In fact, alternative embodiments may include relational databases, Non-SQL data stores, files, text documents, spreadsheets, and/or other viable database structures.

One or more components of the response generation system 175 (e.g., text server 151 and/or the response determination server 157) may have a natural language processing (NLP) engine 153 that is capable of processing or otherwise analyzing text-based queries as discussed herein. The NLP engine 153 may be stored on any of the device of the system (e.g., the text server 151, the response determination server 157, the computing device(s) 152, etc.). The NLP engine comprises text processing through tokenization, stop word removal, lowercasing, stemming and lemmatization, and noise removal to name a few sub-processes. Further, a linguistic analysis may be performed as part-of-speech tagging, dependency parsing, and named entity recognition as further sub-processes. Further, a semantic analysis may be performed on word embeddings, semantic role labeling, sentiment analysis, and coreference resolution.

Security database(s) 200 and/or compliance database(s) 205 may be part or, or in communication with the response generation system 175. The security database(s) 200 may include any information gathered during the monitoring of network and/or device security. The information may be associated with an account, such that the information can be referenced based on the account. In various embodiments, security data may be gathered using telemetry monitoring of networks and/or devices. As such, the security data may be generated at least partially automatically. In such an instance, only entities with access to a network or device associated with the user may be able to gather security data. However, in some instances, the security data may be provided to third parties for processing.

An example security database may include various columns relating to the security data. For example, the security database may include columns named: ID, submission source, type, name, title, category, backgrounds, recommendations, notes, organization ID, organization paths, severity, confidence, PCI severity, priority, customer priority, tags, asset keys, display name, authoritative ID, username, email, name, cidr, MAC address, IP Address, hostname, protocol, port, event IDs, affected items, references, evidences, text, file, source plugins, source tags, cvssV2Vector, cvssV2Score, cvssV3Vector, cvssV3Score, cvssV4Vector, cvssV4Score, cvssV4Exploitability, cvssV4Complexity, cvssV4VulnerableSystem, cvssV4SubsequentSystem, cvssV4Exploitation, cvssV4SecurityRequirements, CVES, CWES, raw, external ID, external event IDs, extras, keys, value, PCI Pass, workflows, events, is Template, is Deleted, created Instant, and last Updated. The columns of the security database above are merely for example and any number of columns may be used in a given security database.

The compliance database(s) 205 may include any information gathered in relation to compliance. The compliance database(s) 205 may be generally gathered from users associated with the account, such as answering questions relating to compliance. Example questions relating to compliance may include network configuration, number of devices, types of usage, and/or the like. The compliance data gathered and stored in a compliance database(s) 205 may include information gathered based on previous testing (e.g., previous audit results). As such, the compliance database(s) 205 may include various information relating to the network and/or device configuration for the account.

The security database(s) 200 and compliance database(s) 205 may include similar or the same columns. In various embodiments, the system may normalize data packets from the security database(s) 200 and/or compliance database(s) 205 based on the columns in each database. For example, the system may normalize the security data and the compliance data to have the same columns (e.g., only shared column titles may be kept in the normalized data). In various embodiments, the security data and the compliance data may be reformatted to be analyzed with one another. For example, the system may generate a vector index for a given data packet with information from the security data or the compliance data. As such, a vector index created for the security data can be compared with a vector index created for the compliance data.

The security database(s) 200 and/or compliance database(s) 205 may be in communication with various components of the response generation system 175 and used to determine a response to a query, as discussed herein.

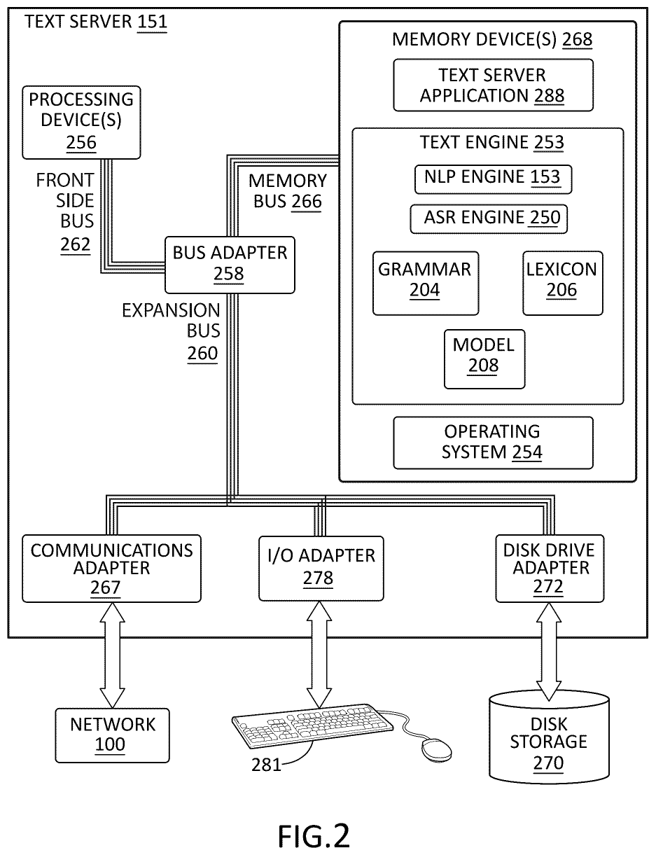

Referring now to FIG. 2, a block diagram illustrating the text server 151 of FIG. 1, in accordance with various embodiments is provided. FIG. 2 is merely illustrative an example text server 151. In various embodiments, the text server 151 may share components with the response determination server 157. The text server 151 may be comprised of one or more servers. In various embodiments, the text server 151 may be capable of processing queries and performing NLP on the queries to be used to determine response to said queries.

The text server 151 of FIG. 2 includes one or more processing devices 256 and one or more memory devices 268, communication adapter 267, an input/output adapter 278, and a disk drive adapter 272. In various embodiments, the various components may be connected to one another via a BUS adapter 258 (e.g., the processing device(s) 256 may be attached via a front side BUS 262, the memory device(s) 268 may be attached via a memory BUS 266, and the communication adapter 267, I/O adapter 278, disk drive adapter 272, and/or other interfaces may be attached via expansion BUS 260).

It should be understood that the memory device(s) 268 may include one or more databases or other data structures/repositories. The memory device 268 also includes computer-executable program code that instructs the processing device(s) 256 to operate the network communication interface (e.g., communication adapter 267) to perform certain communication functions of the system described herein. For example, in one embodiment of the text server 151, the memory device 268 includes, but is not limited to, a text server application 288, a text engine 253, and an operating system 254. The text engine 253 may also include an NLP engine 153, an automatic speech recognition (ASR) engine 250, grammar database(s) 204, lexicon database(s) 206, and/or dynamic text modelling 208.

Some embodiments of the text server 151 include processing device(s) 256 communicably coupled to such components as the memory device(s) 268, the communication adapter 267, the input/output adapter 278, the disk drive adapter 272, and/or the like. The processing device(s) 256, and other processors described herein, generally include circuitry for implementing communication and/or logic functions of the system. For example, the processing device(s) 256 may include a digital signal processor device, a microprocessor device, and various analog to digital converters, digital to analog converters, and/or other support circuits. Control and signal processing functions of the text server 151 are allocated between these devices according to their respective capabilities. The processing device(s) 256 thus may also include the functionality to encode and interleave messages and data prior to modulation and transmission. The processing device(s) 256 can additionally include an internal data modem. Further, the processing device(s) 256 may include functionality to operate one or more software programs, which may be stored in the memory device(s) 268. For example, the processing device(s) 256 may be capable of operating a connectivity program to communicate via the communication adapter 267.

The processing device(s) 256 is configured to connect to the network 100 via the communication adapter 267 to communicate with one or more other devices on the network 100. In this regard, the communication adapter 267 may include various components, such as an antenna operatively coupled to a transmitter and a receiver (together a “transceiver”). The processing device(s) 256 is configured to provide signals to and receive signals from the transmitter and receiver, respectively. The signals may include signaling information in accordance with the air interface standard of the applicable cellular system of the network 100. In this regard, the text server 151 may be configured to operate with one or more air interface standards, communication protocols, modulation types, and access types. By way of illustration, the text server 151 may be configured to operate in accordance with any of a number of first, second, third, fourth, and/or fifth-generation communication protocols and/or the like. In various embodiments, the text server 151 may also be connected via other connection methods to one or more components of the response generation system 175 (e.g., the text server 151 may be hardwired to the response determination server 157).

The I/O adapter 278, which allow the text server 151 to receive data from a user such as a system administrator, may include any of a number of devices allowing the text server 151 to receive data from the user, such as a keypad, keyboard 281, touch-screen, touchpad, microphone, mouse, joystick, other pointer device, button, soft key, and/or other input device(s). The user interface may also include a camera, such as a digital camera.

The disk drive adapter 272 may provide additional storage space via disk storage 270. Various other storage mediums may also be used by the text server 151, such as cloud storage (e.g., transmitted via the communication adapter 267).

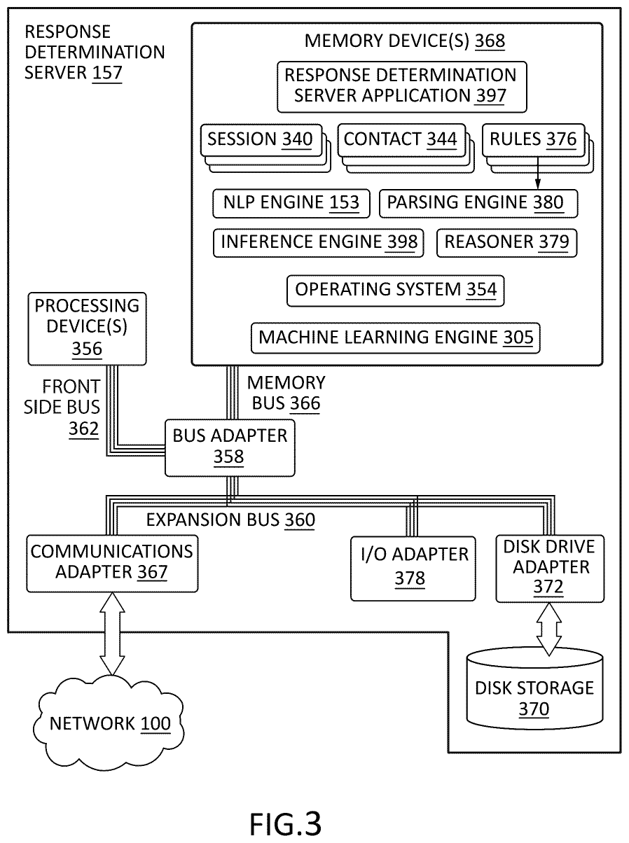

Referring now to FIG. 3, a block diagram illustrating the response determination server 157 of FIG. 1, in accordance with various embodiments is provided. FIG. 3 is merely illustrative an example response determination server 157. In various embodiments, the response determination server 157 may share components with the text server 151. The response determination server 157 may be comprised of one or more servers.

The response determination server 157 of FIG. 3 includes one or more processing devices 356 and one or more memory devices 368, communication adapter 367, an input/output adapter 378, and a disk drive adapter 372. In various embodiments, the various components may be connected to one another via a BUS adapter 358 (e.g., the processing device(s) 356 may be attached via a front side BUS 362, the memory device(s) 368 may be attached via a memory BUS 366, and the communication adapter 367, I/O adapter 378, disk drive adapter 372, and/or other interfaces may be attached via expansion BUS 360).

It should be understood that the memory device(s) 368 may include one or more databases or other data structures/repositories. The memory device 368 also includes computer-executable program code that instructs the processing device(s) 356 to operate the network communication interface (e.g., communication adapter 367) to perform certain communication functions of the system described herein. For example, in one embodiment of the response determination server 157, the memory device 368 includes, but is not limited to, a response determination server application 397, a NLP engine 153, a parsing engine 380 (that receives information relating to sessions 340, contacts 344, and rules 376), an inference engine 398, a reasoner 379, an operating system 354, and a machine learning engine 305.

The response determination server application 397 may be used to determine responses to queries as discussed herein. Additionally, the response determination server application 397 may be capable of communicating with other devices on the network 100 via the communication adapter 367. The processing device(s) 356 may use the information stored in the NLP engine 153, the parsing engine 380, the inference engine 398, and/or the reasoner 379 to determine the response to a query.

Some embodiments of the response determination server 157 include processing device(s) 356 communicably coupled to such components as the memory device(s) 368, the communication adapter 367, the input/output adapter 378, the disk drive adapter 372, and/or the like. The processing device(s) 356, and other processors described herein, generally include circuitry for implementing communication and/or logic functions of the system. For example, the processing device(s) 356 may include a digital signal processor device, a microprocessor device, and various analog to digital converters, digital to analog converters, and/or other support circuits. Control and signal processing functions of the response determination server 157 are allocated between these devices according to their respective capabilities. The processing device(s) 356 thus may also include the functionality to encode and interleave messages and data prior to modulation and transmission. The processing device(s) 356 can additionally include an internal data modem. Further, the processing device(s) 356 may include functionality to operate one or more software programs, which may be stored in the memory device(s) 368. For example, the processing device(s) 356 may be capable of operating a connectivity program to communicate via the communication adapter 367.

The processing device(s) 356 is configured to connect to the network 100 via the communication adapter 367 to communicate with one or more other devices on the network 100. In this regard, the communication adapter 367 may include various components, such as an antenna operatively coupled to a transmitter and a receiver (together a “transceiver”). The processing device(s) 356 is configured to provide signals to and receive signals from the transmitter and receiver, respectively. The signals may include signaling information in accordance with the air interface standard of the applicable cellular system of the network 100. In this regard, the response determination server 157 may be configured to operate with one or more air interface standards, communication protocols, modulation types, and access types. By way of illustration, the response determination server 157 may be configured to operate in accordance with any of a number of first, second, third, fourth, and/or fifth-generation communication protocols and/or the like. In various embodiments, the response determination server 157 may also be connected via other connection methods to one or more components of the text server 151 (e.g., the text server 151 may be hardwired to the response determination server 157).

The I/O adapter 378, which allow the response determination server 157 to receive data from a user such as a system administrator, may include any of a number of devices allowing the response determination server 157 to receive data from the user, such as a keypad, keyboard, touch-screen, touchpad, microphone, mouse, joystick, other pointer device, button, soft key, and/or other input device(s). The user interface may also include a camera, such as a digital camera.

The disk drive adapter 372 may provide additional storage space via disk storage 370. Various other storage mediums may also be used by the response determination server 157, such as cloud storage (e.g., transmitted via the communication adapter 367).

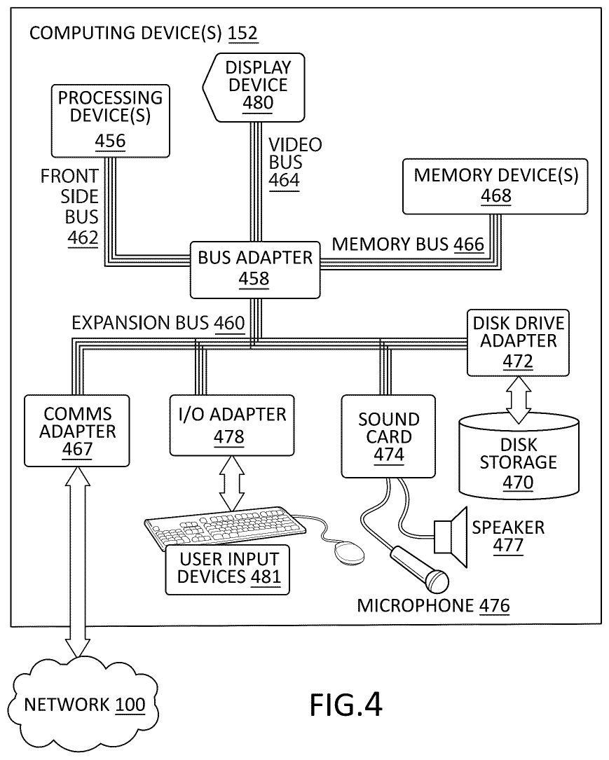

Referring now to FIG. 4, a block diagram illustrating the computing device 152 of FIG. 1, in accordance with various embodiments is provided. FIG. 3 is merely illustrative an example computing device 152. Various types of computing devices 152 may be used or otherwise contemplated for the system. The computing device 152 may be any computing device used by a user to access the automated chat platform 101 shown in FIG. 1. In various embodiments, the automated chat platform 101 may be browser based (e.g., accessed via a website). Additionally or alternatively, the automated chat platform 101 may be accessed via a downloaded software product installed on the computing device 152.

Example computing devices include desktop computers 107, mobile devices, such as mobile phones 112, tablets, smart watches, etc., laptops 126, and/or the like. As such, the computing device 152 may be any device that is capable of accessing the automated chat platform 101 and includes any capabilities of such a computing device. For example, a mobile phone may include communication interfaces to communication with mobile networks and local area networks (e.g., via Wi-Fi).

The computing device 152 of FIG. 4 includes one or more processing devices 456, one or more memory devices 468, a display device 480, a communication adapter 467, an input/output adapter 478, and a disk drive adapter 472. In various embodiments, the various components may be connected to one another via a BUS adapter 458 (e.g., the processing device(s) 456 may be attached via a front side BUS 462, the memory device(s) 468 may be attached via a memory BUS 466, the display device 480 may be attached via a video BUS 464, and the communication adapter 467, I/O adapter 478, disk drive adapter 472, and/or other interfaces may be attached via expansion BUS 460).

It should be understood that the memory device(s) 468 may include one or more databases or other data structures/repositories. The memory device 468 also includes computer-executable program code that instructs the processing device(s) 456 to operate the network communication interface (e.g., communication adapter 467) to perform certain communication functions of the system described herein.

Some embodiments of the computing device 152 include processing device(s) 456 communicably coupled to such components as the memory device(s) 468, the communication adapter 467, the input/output adapter 478, the disk drive adapter 472, and/or the like. The processing device(s) 456, and other processors described herein, generally include circuitry for implementing communication and/or logic functions of the system. For example, the processing device(s) 456 may include a digital signal processor device, a microprocessor device, and various analog to digital converters, digital to analog converters, and/or other support circuits. Control and signal processing functions of the computing device 152 are allocated between these devices according to their respective capabilities. The processing device(s) 456 thus may also include the functionality to encode and interleave messages and data prior to modulation and transmission. The processing device(s) 456 can additionally include an internal data modem. Further, the processing device(s) 456 may include functionality to operate one or more software programs, which may be stored in the memory device(s) 468. For example, the processing device(s) 456 may be capable of operating a connectivity program to communicate via the communication adapter 467.

The processing device(s) 456 is configured to connect to the network 100 via the communication adapter 467 to communicate with one or more other devices on the network 100. In this regard, the communication adapter 467 may include various components, such as an antenna operatively coupled to a transmitter and a receiver (together a “transceiver”). The processing device(s) 456 is configured to provide signals to and receive signals from the transmitter and receiver, respectively. The signals may include signaling information in accordance with the air interface standard of the applicable cellular system of the network 100. In this regard, the computing device 152 may be configured to operate with one or more air interface standards, communication protocols, modulation types, and access types. By way of illustration, the computing device 152 may be configured to operate in accordance with any of a number of first, second, third, fourth, and/or fifth-generation communication protocols and/or the like).

The I/O adapter 478, which allow the computing device 152 to receive data from a user such as a system administrator, may include any of a number of devices allowing the computing device 152 to receive data from the user, such as a keypad, keyboard 481, touch-screen, touchpad, microphone, mouse, joystick, other pointer device, button, soft key, and/or other input device(s). The user interface may also include a camera, such as a digital camera.

The disk drive adapter 472 may provide additional storage space via disk storage 470. Various other storage mediums may also be used by the computing device 152, such as cloud storage (e.g., transmitted via the communication adapter 467).

As described above, the computing device 152 has a user interface that is, like other user interfaces described herein, rendered via the display device 480. The display device 480 include a display (e.g., a liquid crystal display or the like) and/or a speaker or other audio device, which are operatively coupled to the processing device(s) 456. As such queries and/or responses may be provided to the computing device 152 via the display device 480 (e.g., visually via the user interface and/or audibly via the speaker or other audio device). In various embodiments, the display device 480 may be in communication with a sound card 474 (e.g., attached to a microphone 476 and/or a speaker 477 (e.g., the speaker 477 may be part of the display device 480 or standalone).

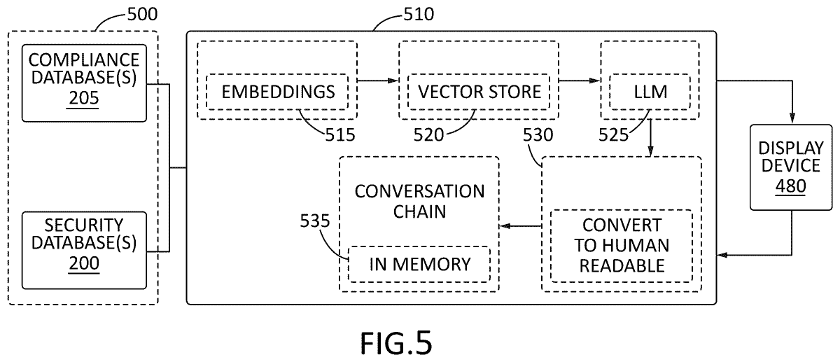

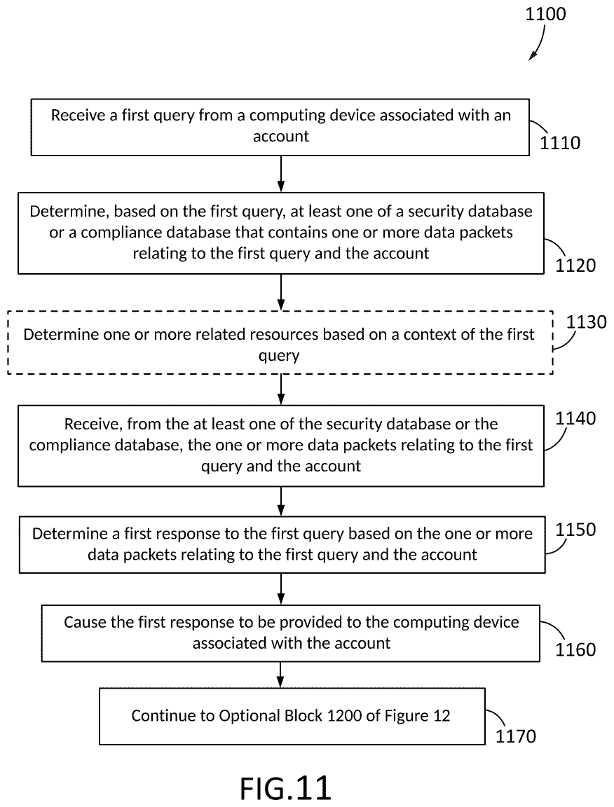

Referring now to FIG. 5, an example diagram is provided illustrating the architecture used to process compliance data and security data to generate a response to a query as discussed herein. The operations are discussed in more detail in reference to FIGS. 11-13. As shown, at Block 500, data packet(s) are received from the security database(s) 200 and/or the compliance database(s) 205. In various embodiments, the data packet(s) received from the security database(s) 200 and/or the compliance database(s) 205 may be associated with a query to which a response is being determined. As such, the data packet(s) received from the security database(s) 200 and/or the compliance database(s) 205 may be associated with a given account (e.g., a user making a query may be associated with an account for an entity).

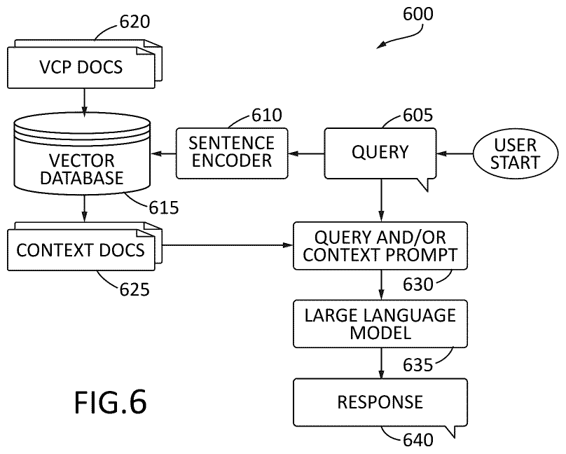

In various embodiments, the response generation system 175 of FIG. 1 may then carry out the operations of Block 510 in order to provide the response to a query via a display device 480 of a computing device 152. For example, at Block 510, the operations may include embedding 515 the data packet(s) received from the security database(s) 200 and/or the compliance database(s) 205, storing the data packet(s) from the security database(s) 200 and/or the compliance database(s) 205 in a vector database at Block 520 (e.g., the vector database may be the same vector database 615 discussed in reference to FIG. 6). As such, the vector database may have one or more entries associated with one or more accounts.

In various embodiments, a machine learning model, such as a large language model (LLM 525) may be used to process the data packet(s) received from the security database(s) 200 and/or the compliance database(s) 205, as well as the query to determine a response to the given query. A LLM is a deep learning algorithm that can perform various types of NLP tasks. The LLM may be part of the NLP engine 153 shown in FIG. 1. Various LLMs may be used in order to determine the meaning of a query, as well as to determine a response to the query.

The data processed and transformed via the LLM 525 may then be converted into a readable medium at Block 530 (e.g., converted to a text-based response to the query). The query and response may be stored in memory of the system as shown in Block 535 (e.g., memory device(s) 268 of the text server 151, memory device(s) 368 of the response determination server 157, memory device(s) 468 of the computing device(s) 152, etc.). The query and response may be stored in conversation format (e.g., a conversation chain). Additionally or alternatively, the response may be provided to a user interface on the display device 480 (e.g., a display device of a computing device associated with a user and/or entity). The user interface of the display device 480 may be the same user interface 700 shown in FIGS. 7A-7C. The query and response may be rendered to the user interface via a conversation format.

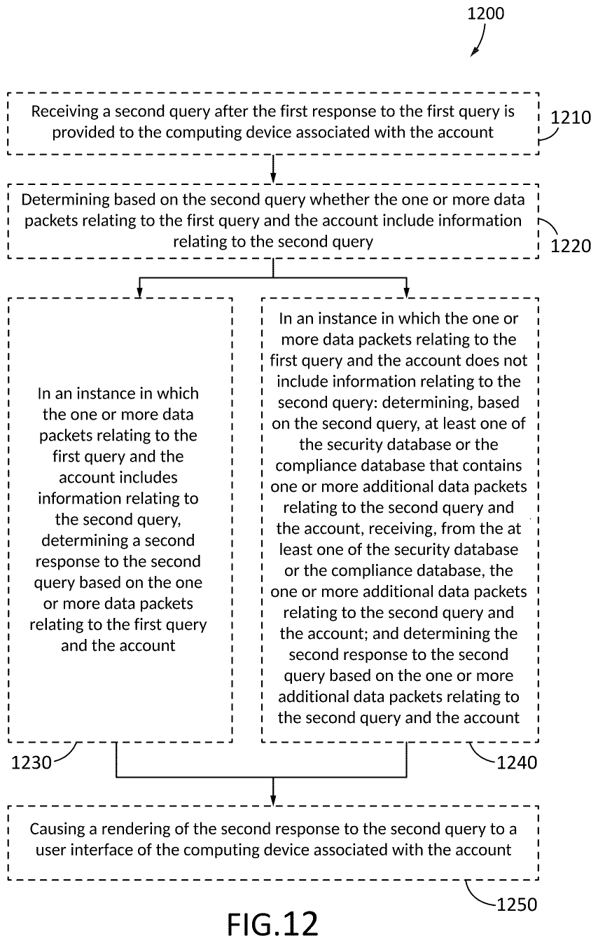

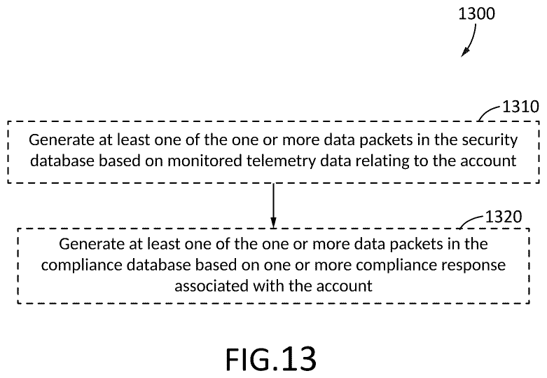

Referring now to FIG. 6, a flowchart 600 is provided illustrating the high-level processing of the operations discussed herein, such as the operations of FIGS. 11-13. The operations of FIGS. 11-13 discussed herein at least partially capture the operations of flowchart 600. As such, the operations of flowchart 600 of FIG. 6 are discussed in more detail in reference to the operations of FIG. 11, FIG. 12, and/or FIG. 13.

As discussed in more detail below in reference to FIG. 11, a user associated with an account may input a query (e.g., a first query, a second query, etc.). The query may be text-based and may be inputted by the user via a chat function on the user interface of a computing device 152. The system of various embodiments may receive the query at Block 605 and determine whether to generate a response based on the query (e.g., advance to Block 630) or use a sentence encoder, such as a sustenance transformer, at Block 610 to analyze the query and compare the query to a vector database 615. The vector database may include one or more documents that include information relating to the account and the content of the query may be used to determine the context docs at Block 625 (e.g., the documents 620 are stored in the vector database). The context docs at Block 625 may correspond to the additional resources discussed in reference to Block 1130 of FIG. 11 below.

At Block 630, the system processes the query and/or the additional resources obtained from the vector database to determine the response. The response may be determined via a large language model as shown at Block 635. The determination of a response is discussed in more detail in reference to FIG. 11. As shown in Block 640, a response to the query is determined and may also be provided to the computing device associated with the query (e.g., the user interface of a computing device 152 may render the response).

Referring now to FIGS. 7A-7C, example user interfaces are shown with conversations between a user and the system in accordance with various embodiments. As shown, the queries may be text-based. Additionally or alternatively, the queries may be received in non-text format (e.g., verbal query) and converted to a textual query. In the example shown in FIGS. 7A-7C, a textbox 705 for a user to enter a query. The textbox 705 may provide a prompt for the user to enter a query (e.g., as shown in FIG. 7A, the textbox states “Ask about your risk in your environment here . . . ”).

In various embodiments, the user interface (e.g., user interface 700) may also provide recommended queries (e.g., frequently entered queries, and/or account specific recommendations may be provided). For example, a user may select a recommended query. The recommended query may be based on the user account, the knowledge level of the user and/or the entity, the entity account, the security data associated with the entity, compliance data associated with the entity, and/or the like. Additionally or alternatively, the recommended query may be based on previous interactions with the account. For example, the recommended query may be a follow-up to a previous query and/or the recommended query may be based on security data and/or compliance data. In various embodiments, the recommended queries may be based on the knowledge level of the user and/or the entity. For example, the system may provide recommended queries to lower knowledge level users than higher knowledge level users.

FIG. 7A illustrates an example user interface with a first query 710A, a first response 710B, a second query 725A, a second response 725B, a third query 730A, and a third response 730B. The displaying of the query and response may be in sequential order (e.g., the first query was received before the second query and the second query was received before the third query). In various embodiments, a time-stamp and/or other indicator may be provided to indicate when a query and/or a response was made. As shown at label 735, the user may be prompted to confirm that a response answered the query. For example, as shown at label 735, the question “What is the overall trend for the Lakeside site?” was answered with the response “The overall trend for the Lakeside site is upwards in severe events.” In various embodiments, in an instance in which a user indicates that a response did not answer a query, an additional response may be generated. For example, the user may want more in-depth information relating to the query or the response may not have answered the query correctly (e.g., the user may have poorly worded the query and/or the system may have misinterpreted the query). Additionally or alternatively, the query may be escalated to a human user to provide a response (e.g., a query may be outside the scope of the automated chat platform due to various reasons, such as incompleteness of the query, specificity of the query, rarity of the query, etc.).

In various embodiments, queries and/or responses from previous sessions (e.g., a predetermined amount of time in which a user accesses a given account) may be stored and displayed via the user interface (e.g., the user may be capable of scrolling through previous queries and responses). Alternatively, the queries and/or responses may merely be available during a given session (e.g., not stored or stored, but not displayed). In various embodiments, queries and/or responses may be stored to be used for training a machine learning model. For example, the queries and/or response may be used to generate recommended queries and/or proactive responses (e.g., a response may include additional information outside the specific scope of a question in an instance in which the machine learning model determines a user may ask additional follow-up questions).

In various embodiments, users and/or automated actors may have a designated avatar. For example, the user of FIG. 7A is represented by avatar 715 and the system is represented by avatar 720. In various embodiments, the avatars may be customizable (e.g., the avatar 715 may be changed to a picture of the user or a picture of the company logo for the associated account).

The user interface 700 of FIG. 7B illustrates additional queries and responses provided in chat format. As shown, a first query 740A, a first response 740B, a second query 745A, a second response 745B, a third query 750A, and a third response 750B may each be provided via the user interface 700.

FIG. 7C illustrates another user interface 700 in which multiple queries and responses are displayed. As shown, a response 755 is shown without a corresponding query shown. In various embodiments, the user interface 700 may have a scrolling function such that the user interface may be manipulated to show the query for the response 755. The response 755 indicates that “Lakeside site” would not be able to pass a PCI audit. The system may simulate the determination of whether a site may pass an audit, as discussed in reference to Block 1110 of FIG. 11. For example, the PCI audit may be a potential test that is simulated.

As shown at query 760A, the query uses the previous query and response, which is directed to a PCI audit for the “Lakeside site”, to ask about another site (e.g., a different sub-group). Here, the system may use the information from the previous query and response to determine the desired information for query 760A. As such, the system can determine that the user wants to know whether Rockdale site will be able to pass a PCI audit. The response 760B indicates that the Rockdale site would be able to pass the PCI audit. Query 765A asks about PCI audits at two more sub-groups (“Southland” and “Hwy 15”) and the response 765B indicates that both sites would be able to pass PCI audits.

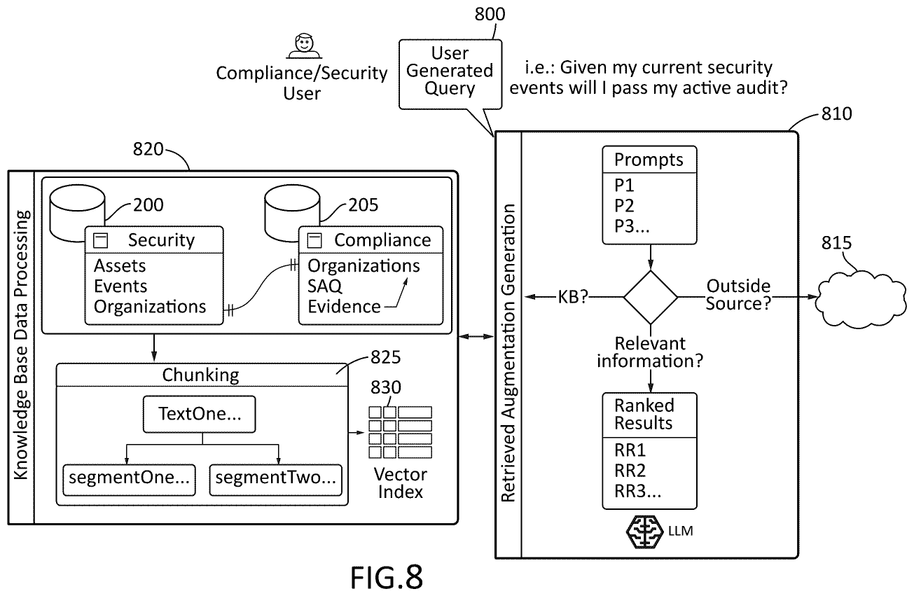

Referring now to FIG. 8, a block diagram is shown illustrating example processing upon receiving a query. The operations of FIG. 8 are described in more detail in reference to FIGS. 11-13. As shown, a user (e.g., via a computing device 152) may submit a query at Block 800. In various embodiments, the query may be any of the queries shown in FIGS. 7A-7C. An example query may be “Given my current security events will I pass my active audit?”.

In various embodiments, the operations of the retrieval augmentation generation engine 810 and the knowledge base data processing engine 820 may be carried out by the response generation system 175 of FIG. 1. For example, the text server 151 may carry out the operations of the retrieval augmentation generation engine 810 and the response determination server 157 may carry out the operations of the knowledge base data processing engine 820. In various embodiments, any number of components of the response generation system 175 and/or the computing device(s) 152 may carry out the operations of FIG. 8.

As shown, the retrieval augmentation generation engine 810 may take the prompt(s) (e.g., queries) and determine ranked results (e.g., potential responses as discussed in reference to Block 1150 of FIG. 11) and then use the LLM and/or other artificial intelligence to determine a response (e.g., the highest ranked potential response). In various embodiments, the retrieval augmentation generation engine 810 may receive information relating to the query from the knowledge base data processing engine 820 and/or outside sources 815.

In various embodiments, the security database(s) 200 and/or the compliance database(s) 205 may be included in the knowledge base data processing engine 820, such that the retrieval augmentation generation engine 810 may receive the data packet(s) discussed in reference to FIG. 11 from the knowledge base data processing engine 820. As shown in the knowledge base data processing engine 820, the system may process any data packet(s) received from the security database(s) 200 and/or the compliance database(s) 205. For example, the knowledge base data processing engine 820 may process the data packet(s) received from the security database(s) 200 and/or the compliance database(s) 205 via chunking 825 terms and/or phrases to create a vector index 830 of the data packet(s).

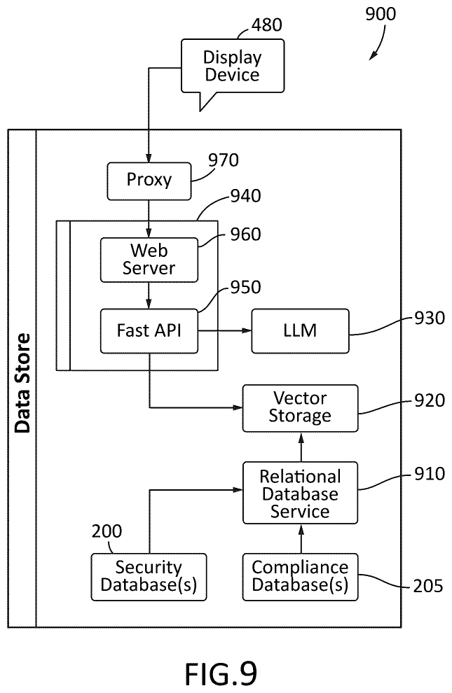

Referring now to FIG. 9, another block diagram 900 is shown illustrating the processing operations of various embodiments. FIG. 9 illustrates various types of software that may be used to carry out the operations discussed herein. The software shown in FIG. 9 is merely illustrative and not a requirement that any specific product or software be used in various embodiments of the present disclosure. As such, as shown, the system may use a proxy 970, such as “Ngnix” Proxy. The web servers 960 and/or the API 950 (e.g. Fast API) may be coded in Python, Java, or any other suitable programming language 940. The LLM(s) may include utilization of models such as “Anthropic Claude” large language model 930 LLM). The vector database 920 may be accessible via Amazon Web Services (AWS) OpenSearch Serverless (AOSS). Additionally, the security database(s) 200 and the compliance database(s) 205 may be stored in a relational database service 910, such as Amazon RDS, MongoDB, MariaDB or others.

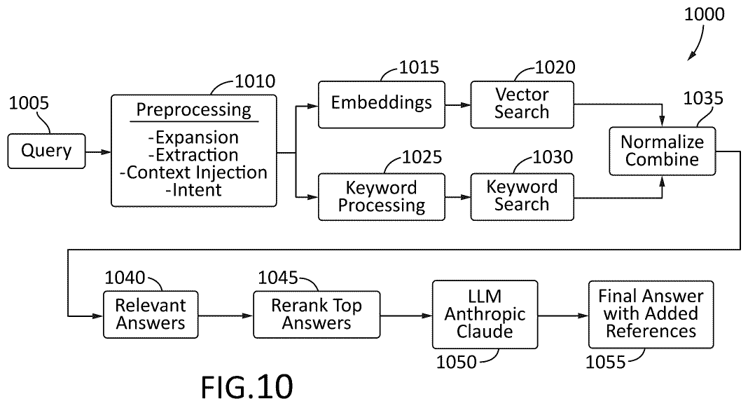

Referring now to FIG. 10, a flowchart 1000 is providing illustrating an example operation of determining a response to a query in accordance with various embodiments. The operations are discussed in more detail below in reference to FIGS. 11-13. The operations may be carried out by any of the system of FIG. 1.

As shown, a query 1005 may be received and preprocessed at Block 1010. Preprocessing may include expansion, extraction, context injection, and/or determining intent of the query. Such preprocessing may be completed using a NLP engine or the like. Upon being preprocessed, the query may be analyzed and processed via embedding 1015 (e.g., using AWS Titan embedding services) and compared with a vector database via a vector search 1020. Additionally, the query may be analyzed for keywords at Block 1025 and use said keywords to search for relevant data (e.g., relevant data packet(s) in the security database(s) 200 and/or the compliance database(s) 205). The search results from the vector search 1020 and the keyword search 1030 may then be combined and normalized at Block 1035. The normalized results include one or more relevant answers 1040 (e.g., relevant responses to the query), which may then be compared to one another to determine a ranking of the responses, as shown at Block 1045. As shown in Block 1050, a LLM and/or other machine learning model(s) may be used to determine the best response to the query. For example, the best response may be the highest ranked response based on the analysis by the LLM and/or other machine learning model(s). The final answer 1055 (e.g., the response) may be provided to the computing device 152 associated with the query. The response may also include information relating to the response, such as additional references for review by the user.

Referring now to FIG. 11, a flowchart 1100 is provided illustrating a method of determining a response to a query in accordance with various embodiments. The method discussed herein may be carried out by one or more of the components discussed in reference to FIG. 1. For example, the method may be carried out by the response generation system 175 (e.g., the response determination server 157, the text server 151, etc.) and/or the client computing device 152. The operations of the method may be carried out by a system as discussed herein. Additionally, a computer program product may include executable portion(s) that are configured to carry out the method herein. Additionally, unless otherwise stated, the operations of FIGS. 11, 12, and 13 may be carried out by the same system, such as the systems of various embodiments discussed herein.

Referring now to Block 1110 of FIG. 11, the method includes receiving a first query from a computing device associated with an account. A query (e.g., a first query, a second query, etc.) may be any request for information relating to an account. In various embodiments, a user may be associated with an account (e.g., an employee may be associated with an account of an employer). As such, the system may know the account based on a user being logged into a user account associated with the account.

In various embodiments, the first query includes a request for a status of a potential test and the first response is determined based on simulating the potential test based on the one or more data packets associated with the first query and the account. For example, a user may submit a query that inquires whether the account would be successful at a given test (e.g., FIG. 7C illustrates multiple queries and responses relating to simulated results of PCI audits at different sites associated with the account). In various embodiments, the system may be capable of simulating the potential tests based on information contained within the security database(s) and/or the compliance database(s). As such, the system may be capable of determining which tests a user is requesting be simulated (e.g., using NLP engine 153), determining one or more requirements for passing/failing a potential test, and comparing said requirements for the account requested. For example, an audit may require that no cyberattacks have occurred within a predetermined amount of time. As such, the system may receive information relating to any cyberattacks on the account from the security database(s) and/or the compliance database(s).

Referring now to Block 1120 of FIG. 11, the method includes determining, based on the first query, at least one of a security database or a compliance database that contains one or more data packets relating to the first query and the account. The system may include or otherwise have access to various databases with information relating to one or more accounts. As such, the databases (e.g., the security database 200 and the compliance database 205) may include information gathered relating to the account associated with the query.

In various embodiments, the system may request data packet(s) from such databases that relate to the account. In various embodiments, the system may request or otherwise receive any data packet(s) associated with the account. For example, the system may transmit a request for any data packet(s) that mention the account and/or include an account identifier.

In various embodiments, the system may request or otherwise receive data packet(s) that are tailored to the specific query. For example, a query may be related to a specific sub-group or part of an account, such that not every data packet related to the account is necessary to determine a response. In various embodiments, the system may determine information relating to the query to be used to determine and/or locate relevant data packets. For example, the method may include determining at least one data packet type based on the first query. The data packet type may be indicated by the first query (e.g., a first query may specifically reference a sub-group of the account and the data packets related to said sub-group may be located within the security database and/or the compliance database). As such, one or more of the data packet(s) relating to the first query and the account may be associated with a specific sub-group (e.g., a first query may request information relating to a specific sub-group and the data packet(s) received by the system may be tailored to the specific sub-group).

Referring now to Block 1130 of FIG. 11, the method includes determining one or more related resources based on a context of the first query. The related resources may be stored in a vector database (e.g., vector database 615 of FIG. 6). In various embodiments, the related resources may be stored from previous queries. As discussed above in reference to FIG. 8, the vector database may also include vectorized information from the security database 200 and/or the compliance database 205. For example, the data packet(s) from the security database 200 and/or the compliance database 205 may be normalized into vector index form to be used herein.

In various embodiments, the one or more related resources may be determined based on a similarity between the first query and at least one entry in a vector database. For example, the related resources may be determined via keyword searching of the vector database based on the first query. The related resources may be used along with the data packet(s) from the security database 200 and/or the compliance database 205 to determine the response.

Referring now to Block 1140 of FIG. 11, the method includes receiving, from the at least one of the security database or the compliance database, the one or more data packets relating to the first query and the account. The system may receive the data packet(s) directly from the security database 200 and/or the compliance database 205, and/or the system may receive the data packet(s) from an intermediate source. For example, the data packet(s) from the security database 200 and/or the compliance database 205 may be normalized or otherwise processed for use by the system before being received. In some embodiments, the system may include such normalizing capabilities. The generation of the data packet(s) is discussed in more detail in FIG. 13.

Referring now to Block 1150 of FIG. 11, the method includes determining a first response to the first query based on the one or more data packets relating to the first query and the account. The first response may be determined based on the data packet(s) received from the security database(s) 200 and/or the compliance database(s) 205. As such, the system uses NLP processing to determine the purpose of the query (e.g., what the user is requesting via the automated chat platform 101).

In various embodiments, the determination of the first response to the first query based on the one or more data packets relating to the first query and the account includes determining one or more potential responses based on the first query and the account. In such an embodiment, the potential response(s) are then compared to one another to determine a ranking of the one or more potential responses based on a relevance to the first query. The ranking may be a weighted calculation based on various response parameters, such as similarity to the query, similarity to previous responses, relevance of the response to the operations of the account (e.g., the browsing of the user associated with the account may be monitored using an interface such that the browsing history may indicate the relevance of the response), and/or the like. As such, the first response may be based on the ranking of the potential response(s). For example, the first response may be the potential response with the highest ranking. In various embodiments, the first response may include more than one potential response. For example, the first response may provide multiple responses (collectively considered the first response) to allow a user to select the response that is most relevant to the first query.

In various embodiments, the first response is determined using LLM(s) and/or machine learning model(s). For example, the system may process one or more potential response via the LLM(s) and/or machine learning model(s) to determine the potential response that is the most relevant to the first query. For example, the LLM(s) and/or machine learning model(s) may determine the likelihood that a first response answers the first query based on analyzing one or more nodes within the first query. Based on the enterprise knowledge graph 154, the system may determine the potential response that is the nearest node to the first query. For example, a potential response that is the nearest node to the first query may be the response that has the smallest number of edges between the potential response node and the first query node.

The LLM(s) and/or machine learning model(s) may also be used to at least partially determine the first response. As such, the LLM(s) and machine learning model(s) may provide answers for the system based on similar queries and/or responses from the same account and/or different accounts. For example, the LLM(s) and/or machine learning model(s) may provide a template for responding to a common query and the system may complete the template based on information specific to the account (e.g., data from the security database and/or the compliance database) to provide a response. The queries and responses discussed herein may be used to teach and/or update LLM(s) and/or machine learning model(s).

While the operations refer to a first query and a first response, the operations of flowchart 1100 may be carried out on any number of queries (e.g., a second response to a second query, a third response to a third query, etc. may be carried out with the same operations discussed in reference to the first query and the first response). In some embodiments, as discussed in reference to flowchart 1200 of FIG. 12, the response and/or data packets used to determine the response to a query may be used to determine a response for subsequent queries (e.g., the system may use one or more previous queries to determine a response for a given query). As such, the ordering of the queries may provide a conversational format. For example, the system may use multiple queries (e.g., a first query and a second query) to generate a second response to a second query and each of the queries and responses may be displayed to the user as an automated chat platform.

Referring now to Block 1160 of FIG. 11, the method includes causing the first response to be provided to the computing device associated with the account. In various embodiments, causing the first response to be provided to the computing device associated with the account includes causing a rendering of the first response to the first query to a user interface of the computing device associated with the account.

In various embodiments, the user interface displays the first query and the first response in an instance in which the first response is rendered on the user interface. In various embodiments, one or more queries (e.g., a first query, a second query, a third query, etc.) and one or more responses (e.g., a first response, a second response, a third response, etc.) may be rendered on the user interface in the form of a textual conversation (e.g., a chat between the user associated with the account and the system). Examples of the first response being provided to the computing device are shown in FIGS. 7A-7C in which the user interface 700 shows multiple queries and responses via a conversational format. The system may be capable of receiving queries and/or providing responses in non-visual methods. For example, the system may be capable of receiving textual and/or spoken queries and providing textual and/or spoken responses.

Referring now to optional Block 1170 of FIG. 11, the method may be continued as discussed below in reference to FIG. 12. As discussed, the system is capable of providing additional responses (e.g., a second response). While the present disclosure references a first query, a second query, a first response, and a second response, any number of queries and responses may be handled by the operations herein.

As discussed herein, additional responses (e.g., second response, third response, etc.) may be related to the previous queries (e.g., a first query) and/or previous responses (e.g., a first response). For example, previous queries and/or responses may be used to determine the response to the additional query (e.g., previous queries and responses may indicate the topic discussed in the present additional query). Alternatively, additional responses for additional queries may be determined independent of previous queries and/or responses. For example, the system may consider each query independently or the system may determine that a given additional query does not relate to previous queries and/or responses.

Referring now to FIG. 12, a flowchart 1200 is provided illustrating a method of determining additional responses to additional queries in accordance with various embodiments. The method discussed herein may be carried out by one or more of the components discussed in reference to FIG. 1. For example, the method may be carried out by the response generation system 175 (e.g., the response determination server 157, the text server 151, etc.) and/or the client computing device 152. The operations of the method may be carried out by a system as discussed herein. Additionally, a computer program product may include executable portion(s) that are configured to carry out the method herein. The operations of FIG. 12 may be a continuation of the operations of FIG. 11.

Referring now to optional Block 1210 of FIG. 12, the method includes receiving a second query after the first response to the first query is provided to the computing device associated with the account. As shown in FIGS. 7A-7C, a user may have multiple queries for which the user is requesting a response. In some instances, the queries are related (e.g., the queries may be the same type of request for different sub-groups, as shown in FIG. 7C in which the user requests a prediction for a PCI audit across different sites). Alternatively, a user may submit completely independent queries. As such, the operations of FIG. 12 determine whether a query (e.g., the second query) is related to a previous query (e.g., the first query).

Referring now to optional Block 1220 of FIG. 12, the method includes determining based on the second query whether the one or more data packets relating to the first query and the account include information relating to the second query. In various embodiments, the data packet(s) relating to the first query may also include information to generate a response to the second query. As such, the system may not need to retrieve and/or request any additional information to determine a response to the second query. Alternatively, the data packet(s) associated with the first query may partially assist the system in determining the second response and, as such, allows for less data packet(s) to have to be retrieved and/or requested relating to the second query. For example, the data packet(s) relating to the first query may include broad information that also applies to the second query, such that fewer data packet(s) related to the second query may be needed to determine a response.

Based on the determination of optional Block 1220, the operations either continue to optional Block 1230 in an instance in which the one or more data packets relating to the first query and the account includes information relating to the second query, or continue to optional Block 1240 in an instance in which the one or more data packets relating to the first query and the account does not include information relating to the second query.

Referring now to optional Block 1230 of FIG. 12, the method includes determining a second response to the second query based on the one or more data packets relating to the first query and the account in an instance in which the one or more data packets relating to the first query and the account includes information relating to the second query. As discussed herein, the information (e.g., data packet(s)) used to determine a response for a given query may also be used to determine a response for a different query. As such, in an instance in which the one or more data packets relating to the first query and the account includes information relating to the second query, the system may be capable of determining the second response without any additional information. In such an instance, the operations may be the same (e.g., determine potential responses, rank the potential responses, determine the response, etc.) as the determination operations discussed in reference to Block 1150 of FIG. 11 for the first response.

Referring now to optional Block 1240 of FIG. 12, in an instance in which the one or more data packets relating to the first query and the account does not include information relating to the second query, the method includes determining, based on the second query, at least one of the security database or the compliance database that contains one or more additional data packets relating to the second query and the account, receiving, from the at least one of the security database or the compliance database, the one or more additional data packets relating to the second query and the account; and determining the second response to the second query based on the one or more additional data packets relating to the second query and the account.

In various embodiments, in an instance the second query is not related to the first query (e.g., the one or more data packets relating to the first query and the account does not include information relating to the second query), the response may be determined as if the second query was a first query (e.g., the second query, not with any other queries, may be used to determine the response). For example, the operations of optional Block 1240 may be the same as the operations of Blocks 1120, 1130, 1140, and 1150 of FIG. 11 with the second query instead of the first query.

Referring now to optional Block 1250 of FIG. 12, the method includes causing a rendering of the second response to the second query to a user interface of the computing device associated with the account. In various embodiments, the second response may be rendered to the computing device whether determined via the operations of optional Block 1230 or optional Block 1240. Additionally, the second response may be rendered in the same way that the first response was rendered in Block 1160 of FIG. 11.

As shown in FIGS. 7A-7C, the first response to the first query and the second response to the second query may be rendered to the user interface upon the second response being rendered to the user interface of the computing device associated with the account. In various embodiments, any number of queries and/or responses may be provided on the user interface. In various embodiments, previous queries and/or responses may be saved, either short-term (e.g., during a session) or long-term (e.g., stored in memory for future sessions). As such, the conversational format shown in FIGS. 7A-7C may be from a single session (e.g., the chat may only provide queries and responses from the current session) or multiple sessions (e.g., the chat may provide queries and response from the current session and/or previous sessions). In various embodiments, queries and responses within a predetermined amount of time may be displayed (e.g., the chat may include any queries and responses within the past year). In some instances, queries and responses from the immediately preceding session may be provided. For example, a user may submit queries relating to a topic via the chat platform and the user may want to reference said queries in the next session.

Referring now to FIG. 13, a flowchart 1300 is provided illustrating a method of generating one or more of the data packet(s) discussed above in reference to FIGS. 11 and 12, in accordance with various embodiments. The method discussed herein may be carried out by one or more of the components discussed in reference to FIG. 1. For example, the method may be carried out by the response generation system 175 (e.g., the response determination server 157, the text server 151, etc.) and/or the client computing device 152. The operations of the method may be carried out by a system as discussed herein. Additionally, a computer program product may include executable portion(s) that are configured to carry out the method herein.

Referring now to optional Block 1310 of FIG. 13, the method includes generating at least one of the one or more data packets in the security database based on monitored telemetry data relating to the account. In various embodiments, networks and computing devices may be monitored. For example, a company may have a software installed on the network to monitor the operations of the network (e.g., network health, network capacity, network usage, device health, device capacity, device usage, and/or the like). Such security data may be stored for processing as discussed herein. In various embodiments, the security database(s) 200 may store raw data and/or processed data (e.g., normalized across the entire database).

The security database(s) 200 may include any information gathered during the monitoring of network and/or device security. The information may be associated with an account, such that the information can be referenced based on the account. In various embodiments, security data may be gathered using telemetry monitoring of networks and/or devices. As such, the security data may be generated at least partially automatically. As such, only entities with access to a network or device associated with the user may be able to gather security data. However, in some instances, the security data may be provided to third parties for processing.

Referring now to optional Block 1320 of FIG. 13, the method includes generating at least one of the one or more data packets in the compliance database based on one or more compliance response associated with the account. The compliance database(s) 205 may include any information gathered in relation to compliance. The compliance database(s) 205 may be generally gathered from users associated with the account, such as answering questions relating to compliance. Example questions relating to compliance may include network configuration, number of devices, types of usage, results of past tests, and/or the like. The compliance data gathered and stored in a compliance database(s) 205 may include information gathered based on previous testing (e.g., previous audit results). As such, the compliance database(s) 205 may include various information relating to the network and/or device configuration for the account.

The security database(s) 200 and compliance database(s) 205 may include similar or the same columns. In various embodiments, the system may normalize data packets from the security database(s) 200 and/or compliance database(s) 205 based on the columns in each database. For example, the system may normalize the security data and the compliance data to have the same columns (e.g., only shared column titles may be kept in the normalized data). In various embodiments, the security data and the compliance data may be reformatted to be analyzed with one another. For example, the system may generate a vector index for a given data packet with information from the security data or the compliance data. As such, a vector index created for the security data can be compared with a vector index created for the compliance data.

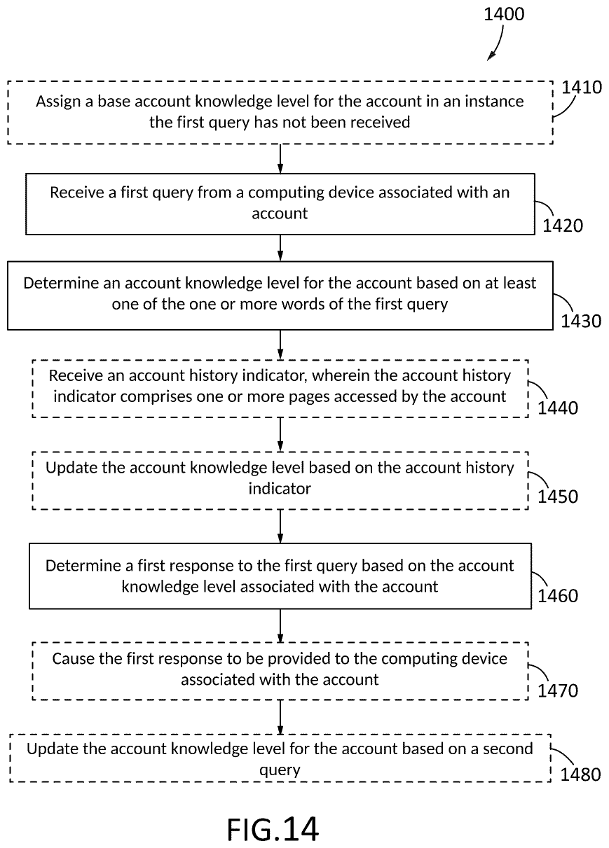

Referring now to FIG. 14, a flowchart 1400 is provided illustrating a method for providing personalized security information based on prompt responses in accordance with various embodiments. The method discussed herein may be carried out by one or more of the components discussed in reference to FIG. 1. For example, the method may be carried out by the response generation system 175 (e.g., the response determination server 157, the text server 151, etc.) and/or the client computing device 152. The operations of the method may be carried out by a system as discussed herein. Additionally, a computer program product may include executable portion(s) that are configured to carry out the method herein. Additionally, unless otherwise stated, the operations of FIG. 14 may be carried out by the same system or systems as the operations of FIGS. 11, 12, and 13, such as the systems of various embodiments discussed herein.

In various embodiments, the operations of FIG. 14 may be used on the automated chat platform 101 discussed herein. As such, a user of varying levels of sophistication may interact with the automated chat platform 101. Some users may understand security requirements, terminology, etc. better than others. As such, a one-size-fits-all chat experience may result in less than optimal results, as some users may understand the information being provided or some users may want more in depth information.

As discussed in reference to FIG. 14, the system may determine an account knowledge level for a user. The account knowledge level may be at a user level (e.g., each individual person within an entity may have a different account knowledge level) and/or an entity level (e.g., an entity using the automated chat platform 101 may each receive the same user experience). While the operations herein discuss dynamically adjusting responses to queries, various other portions of the user experience may be changed based on the account knowledge level. For example, the level of access to certain pages, the way in which data is presented, and/or the like may be changed based on the account knowledge level.

Referring now to optional Block 1410 of FIG. 14, the method includes assigning a base account knowledge level for the account in an instance the first query has not been received. In various embodiments, an account may receive a base account knowledge before any account knowledge level is determined. For example, every account upon creation may be assigned a base account knowledge level. The base account knowledge may be determined by a system administrator (e.g., the base account knowledge level may be the lowest knowledge level or an average knowledge level). As such, new accounts may receive similar user experiences before the account knowledge level are individualized.

In various embodiments, the base account knowledge level may be assigned based on the entity (e.g., the industry of the entity), the title of the user (e.g., cybersecurity officer may have a higher base account knowledge level than a non-cybersecurity position), user information (e.g., user accreditations, user education, user past experience, etc.), and/or the like. The base account knowledge level may be generic (e.g., every new account may have the same base account knowledge level). In various embodiments, the base account knowledge level may be based on information provided by the account and/or entity. For example, a new account may indicate an account knowledge level.

In various embodiments, the base account knowledge level may be based on security data and/or compliance data. For example, the base account knowledge level may be based on the sophistication of the entity (e.g., indicated by the security data and/or the compliance data). As such, the system may receive one or more data packet(s) from the security database and/or the compliance database that is associated with the account and/or entity and use said data packet(s) to determine a base account knowledge level.

Additionally or alternatively, security data and/or compliance data obtain during operations may be used to update the account knowledge level for the entity and/or account. For example, in an instance in which the security data and/or compliance data indicates that the account and/or entity is involved in more complex cybersecurity-related activities, the account knowledge level may be adjusted). In various embodiments, the security data and/or compliance data may be used to compare the account knowledge level of the entity and/or account to the sophistication of the activities of the entity and/or account.

In various embodiments, determining the account knowledge level for the account based on at least one of the one or more words of the first query (e.g., as discussed below in reference to Block 1430 of FIG. 14) includes updating the base account knowledge level based on the at least one of the one or more words of the first query. In various embodiments, the account knowledge level may be adjusted over time (e.g., based on new queries or other user interactions with the system). Additionally or alternatively, the account knowledge level may be adjusted based on outside information provided to the system (e.g., an entity or user may provide information relating to knowledge level, such as accreditations, past experience, education, and/or the like).

In various embodiments, the base account knowledge level may be determined based on an input provided by a user associated with the account. For example, a user may be prompted to indicate a knowledge level for the account. The user indicated account knowledge level may be used until the system determines the specific account knowledge level using the operations herein (e.g., the system may determine whether the user provided information was accurate based on queries provided). For example, in the operations discussed below in reference to Block 1430, determining the account knowledge level for the account based on at least one of the one or more words of the first query may include comparing the indicated knowledge level for the account to the information in the first query (e.g., the word(s) used in the first query may indicate whether the indicated knowledge level was accurate). As such, the knowledge level may be confirmed and/or updated. In various embodiments, a confidence level may be associated with the account knowledge level that indicates the likelihood of the accuracy of the account knowledge level.

Referring now to Block 1420 of FIG. 14, the method includes receiving a first query from a computing device associated with an account. The first query may be a query, such as the queries discussed herein. In various embodiments, the first query may be textual (or converted into textual via speech to text capabilities). As such, the first query includes one or more words that are related to the account. The first query may be processed using various NLP capabilities. While the operations of Block 1420 refer to a first query, the query may not necessarily be the first query ever received by the system from the user. For example, the first query may merely be the first query analyzed by the system (e.g., some queries may not provide any information relating to knowledge level).

Referring now to Block 1430 of FIG. 14, the method includes determining an account knowledge level for the account based on at least one of the one or more words of the first query. In various embodiments, the account knowledge level indicates a sophistication of the account (and/or the user associated with the account). Accounts may be divided into multiple different account knowledge levels, for which the responses generated are different. The differences in responses may include the terminology used, the amount of information provided, the type of information provided, and/or the like. As discussed above, all accounts related to an entity may have the same account knowledge level. Alternatively, each account (e.g., each user) may have an individual account knowledge level.

The account knowledge level may be determined based on the terminology of the first query. The terminology used by an account may indicate the level of sophistication. The system, via the machine learning model(s), may be capable of comparing the terms used by an account and terms used by other accounts. Additionally or alternatively, certain terms or phrases may be likely indicators of knowledge level. In such an instance, the system may have a database of terms and/or phrases that correspond to a given account knowledge level. For example, IT experts may use a specific term, while non-experts may use a different word for the same thing. As such, an account using the same term as the IT expert may indicate a higher knowledge level.

In various embodiments, a machine learning model used to determine the account knowledge level via terminology may be trained with queries from accounts in which an account knowledge level is known. For example, previous queries and responses may be used as training sets for the machine learning model(s). In various embodiments, the account knowledge level of the accounts used for training sets may be manually assigned (e.g., a user may assign the account knowledge level to a given account manually) and/or automatically (e.g., using the operations herein to determine the account knowledge level for the account).

In various embodiments, the system may assign an account to one of a plurality of account knowledge levels. The account knowledge level may be specific to a type of query and response (e.g., a user may have varying levels of knowledge for different areas). Additionally or alternatively, the account knowledge level may be assigned based on the total knowledge base of the account (e.g., knowledge across each area covered by the system). The number of different account knowledge levels may vary. As such, any number of different account knowledge levels may be contemplated (e.g., a first account knowledge level, a second account knowledge level, a third account knowledge level, etc.).

In various embodiments, the different account knowledge levels may have a hierarchical order, such that a first account knowledge level is considered to have a higher knowledge level than a second account knowledge level. As discussed herein, different account knowledge levels may result in different responses being received by an account. For example, the first account knowledge level may receive more information than the second account knowledge level, which is considered to have a lower knowledge level.

In various embodiments, the account knowledge level for the user and/or entity may be based on information outside of any queries (e.g., the first query, the second query, etc.). In various embodiments, the system may use the information from the one or more queries and information outside of the one or more queries to determine the account knowledge level. For example, the terminology used in the one or more queries may be used to determine an account knowledge and the outside information may be used to verify or update the account knowledge level (e.g., the industry of the entity may be used to determine the account knowledge level).

While the operations herein in determining the account knowledge level include using the first query, any number of queries may be used to determine the account knowledge level for an account. For example, the account knowledge level may be determined after a predetermined number of queries from the account have been received (e.g., multiple queries are used to make a determination of the account knowledge level). Additionally, as discussed below in reference to optional Block 1480, the account knowledge level may be updated upon additional queries being received. For example, additional queries may indicate that an account has a higher level of sophistication than previously determined and/or indicate that the user knowledge level is increasing. As such, the user experience may adjust based on the account gaining more knowledge. For example, a new account may have little base knowledge, but may quickly improve the knowledge level and the system can detect such an increase in sophistication.

Referring now to optional Block 1440 of FIG. 14, the method includes receiving an account history indicator. In addition, or alternatively, to determine the account knowledge level based on queries by an account, the system may determine the account knowledge level based on the pages visited by the account (e.g., the type of pages visited, the volume of pages visited, duration spent on pages, metadata associated with those pages, such as links clicked or hover data, and/or the like). As such, the account history indicator may include a record of account browsing, such as pages accessed by the account, the location that was accessed, the number of times a given page was accessed, the interaction (button clicks, link clicks, image or video play and pause, hover events, drag and drop operations, key board presses, or other action) with a given page, and/or the like. The account history indicator may be account history associated with the specific user, other users also associated with the entity, and/or the entity as a whole (e.g., each user within an entity may have the same account history indicator).

Each page on a website or program may be assigned a complexity level. For example, a beginner training page may indicate a low complexity level, as the beginner training page is intended to teach a user how to do a specific task. Alternatively, a page directed to specific security techniques may have a higher complexity level, as there is little to no reason for a novice user to access the given page. As such, accessing higher complexity level pages may indicate that an account has a higher knowledge level and as such, the account knowledge level may be adjusted based on the given complexity level of visited websites and/or used programs (e.g., visiting higher complexity level may cause an account knowledge level to be increased).

In various embodiments, the volume of page visits may also indicate one parameter of the knowledge level of the account. For example, even an expert may visit a training page once or twice as a refresher, but visiting the training page many times may indicate that a user associated with the account does not have any background relating to the training. As such, the system may determine and/or update the account knowledge level based on the account history indicators, as discussed in reference to Block 1450 of FIG. 14.

Referring now to optional Block 1450 of FIG. 14, the method includes updating the account knowledge level based on the account history indicator. As discussed above in reference to optional Block 1440, the complexity level of pages visited may affect the account knowledge level for the account. As such, visiting higher complexity pages may cause an account knowledge level to be increased.

The system may consider the account history indicator as a whole (e.g., the different pages and frequency may each be considered in determining any changes to the account knowledge level) and/or directed to specific pages (e.g., certain pages may be better indicators of the account knowledge level than others). For example, the system may not consider any pages that are unrelated to security for updating an account knowledge level relating to security.

In various embodiments, the account history indicator may be limited to a specific time period (e.g., a predetermined amount of time). For example, the freshness of the account history indicator may improve the accuracy of the account knowledge level, as a user may increase account knowledge level over time.

Referring now to Block 1460 of FIG. 14, the method includes determining a first response to the first query based on the account knowledge level associated with the account. Additionally, additional responses to the account may also be adjusted based on the account knowledge level. The differences in responses based on account knowledge level may include the terminology used, the amount of information provided, the type of information provided, and/or the like. As such, the responses are personalized based on the account knowledge level.

In various embodiments, a response (e.g., a first response) may have one or more words that are given complexity levels, such that the response has a response complexity level based on one or more words used in the response. The words in the response are determined based on the account knowledge level. In an example in which the account knowledge level may be novice, intermediate, or expert, the words used may be different for each different account knowledge level. For example, a “novice” may not understand certain words or phrases that an “expert” would understand, while an “intermediate” may understand some of the “expert” terminology, but not all of the “expert” terminology. As such, each of the novice, intermediate, and expert account knowledge levels may receive different response for the same type of query.

In various embodiments, the amount of information provided in a response (e.g., a first response) may be based on the account knowledge level of the account. Using the example of novice, intermediate, or expert account knowledge levels, a “novice” may not need or be able to understand information relating to a query that an intermediate or expert may be expecting. As such, the amount of information may be different based on the account knowledge level.

Additional information provided to the user may be based on the account knowledge level. For example, the amount of assistance provided to a user during operation may be based on the account knowledge level. As such, the system may provide more assistance (e.g., more FAQs, more tutorials, more recommended queries, etc.) to users with lower account knowledge levels. Additionally, certain aspects of the user experience may be provided based on the account knowledge level. For example, more information may be provided to users with a higher account knowledge level.

Referring now to optional Block 1470 of FIG. 14, the method includes causing the first response to be provided to the computing device associated with the account. The first response and any subsequent responses may be provided to the computing device associated with the account in the same way described in reference to Block 1160 of FIG. 11. As such, the first response may be rendered on a user interface for a user to engage (e.g., such as shown in FIGS. 7A-7C).

Referring now to optional Block 1480 of FIG. 14, the method includes updating the account knowledge level for the account based on a second query. As discussed above, the account knowledge level may be updated upon additional queries being received from the account. For example, additional queries may indicate that an account has a higher or lower level of sophistication than previously determined. As such, the user experience may adjust based on the account gaining more knowledge. For example, a new account may have little base knowledge, but may quickly improve the knowledge level and the system can detect such an increase in sophistication. As such, the information provided to a user with lower account knowledge level may have less provided in terms of information (e.g., a user with a lower knowledge level may not understand certain statistics, terms, and/or the like). The information provided may extend to the automated chat platform 101 (e.g., as shown in FIGS. 7A-7C) and/or other portions of a user portal.

The account knowledge level may also be updated based on factors outside of the automated chat platform 101. For example, the account knowledge level may be updated based on operations performed by an account and/or entity (e.g., training, new hires with specific expertise, results of outside cybersecurity tests, etc.). As such, the account knowledge level may be updated periodically (e.g., every day, week, month, year, etc.) and/or upon specific milestones by the account and/or user.

In various embodiments, the account knowledge level (either current or historical) may also be used to provide training recommendations and/or requirements for the account and/or entity. For example, an account with a lower account knowledge level may be suggested or required to take training that improves the account knowledge level. The training recommendations and/or requirements may be provided as a part of the automated chat platform 101 (e.g., a response may include materials to better understand a topic) and/or independent (e.g., an account may have a portal that includes training materials and the account knowledge level may be used to recommend and/or require specific training materials).

The account knowledge level may be monitored over time to determine an effectiveness of the training. For example, the account knowledge level for an account and/or entity may be monitored after a training is taken to determine whether the account knowledge level has increased (e.g., does the account now use terminology that is more sophisticated). As such, the account knowledge level may be used to determine the effectiveness of training modules, allowing the system to better recommend training to the account and/or entity (e.g., an account may show greater improvement after watching a video than an instance in which the same account reads an informative paper).

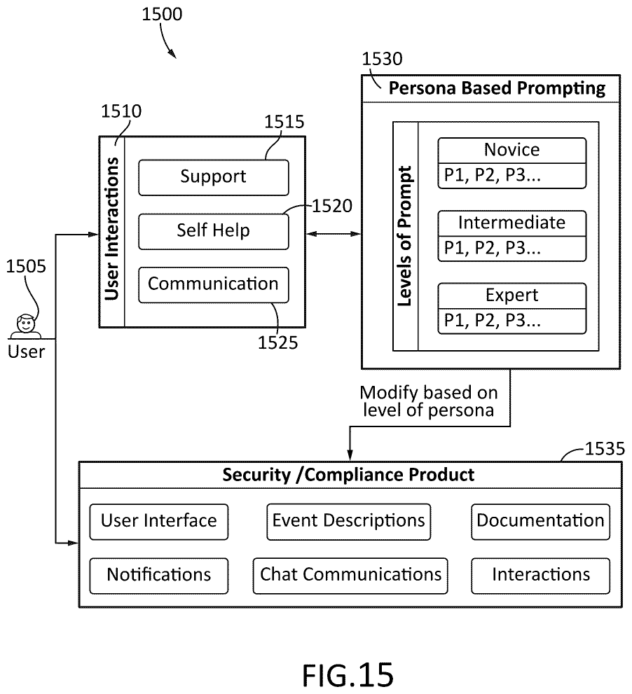

Referring now to FIG. 15, a diagram 1500 is shown illustrating how the personalized user experience is used in accordance with various embodiments. As shown, a user 1505 (e.g., via a computing device 152) may use a platform (e.g., an automated chat platform 101) that monitors user interactions 1510, such as support requests 1515 (e.g., queries submitted with the automated chat platform 101), self-help 1520 (e.g., accessing training materials, etc.), and communication 1525 (e.g., communication between users). As discussed in reference to FIG. 14, the various user interactions may be used to determine an account knowledge level. As shown in Block 1530, the account knowledge level may be any number of levels, such as novice, intermediate, and expert. The account knowledge level may affect the prompts to an account, the response to queries, and/or the like.

As shown in Block 1535, the account knowledge level may affect various different aspects of a product (e.g., a security and/or cybersecurity compliance product). For example, the account knowledge may affect the user interface (e.g., information presented via the user interface), event descriptions (e.g., terminology may be adjusted for different account knowledge levels), documentation (e.g., the documentation requirements may be different based on account knowledge level), notifications (e.g., a higher account knowledge level may get more notifications for complex topics, while lower account knowledge levels may receive more “how-to” or tips notifications), chat communications (e.g., the automated chat platform 101), interactions with the product (e.g., access to certain portions of the product may be limited based on account knowledge level). As such, the system dynamically adjusts the user experience based on the account knowledge level.

### III. Claim Clauses

Clause 1. A method for providing personalized security information based on prompt responses, the method comprising: receiving a first query from a computing device associated with an account, wherein the first query comprises one or more words that are related to the account; determining an account knowledge level for the account based on at least one of the one or more words of the first query, wherein the account knowledge level indicates a sophistication of the account; and determining a first response to the first query based on the account knowledge level associated with the account, wherein a response complexity level of one or more words used in the first response are based on the account knowledge level.
Clause 2. The method of Clause 1, further comprising: receiving an account history indicator, wherein the account history indicator comprises one or more pages accessed by the account; and updating the account knowledge level based on the account history indicator.
Clause 3. The method of Clause 2, wherein each of the one or more pages are assigned a complexity level, wherein a higher complexity level indicates that the account knowledge level is higher.
Clause 4. The method of Clause 1, further comprising updating the account knowledge level for the account based on a second query.
Clause 5. The method of Clause 1, wherein the account knowledge level is determined to be one of a plurality of account knowledge levels, wherein a first account knowledge level is higher than a second account knowledge level.
Clause 6. The method of Clause 5, wherein the first response is different in an instance in which the account knowledge level for the account is the first account knowledge level than in an instance in which the account knowledge level for the account is the second account knowledge level.
Clause 7. The method of Clause 1, further comprising assigning a base account knowledge level for the account in an instance the first query has not been received.
Clause 8. The method of Clause 7, wherein determining the account knowledge level for the account based on at least one of the one or more words of the first query comprises updating the base account knowledge level based on the at least one of the one or more words of the first query.
Clause 9. The method of Clause 1, further comprising causing the first response to be provided to the computing device associated with the account.
Clause 10. A system for providing personalized security information based on prompt responses, the system comprising: at least one non-transitory storage device; and at least one processing device coupled to the at least one non-transitory storage device, wherein the at least one processing device is configured to: receive a first query from a computing device associated with an account, wherein the first query comprises one or more words that are related to the account; determine an account knowledge level for the account based on at least one of the one or more words of the first query, wherein the account knowledge level indicates a sophistication of the account; and determine a first response to the first query based on the account knowledge level associated with the account, wherein a response complexity level of one or more words used in the first response are based on the account knowledge level.
Clause 11. The system of Clause 10, wherein the at least one processing device is further configured to: receive an account history indicator, wherein the account history indicator comprises one or more pages accessed by the account; and update the account knowledge level based on the account history indicator.
Clause 12. The system of Clause 11, wherein each of the one or more pages are assigned a complexity level, wherein a higher complexity level indicates that the account knowledge level is higher.
Clause 13. The system of Clause 10, wherein the at least one processing device is further configured to update the account knowledge level for the account based on a second query.
Clause 14. The system of Clause 10, wherein the account knowledge level is determined to be one of a plurality of account knowledge levels, wherein a first account knowledge level is higher than a second account knowledge level.
Clause 15. The system of Clause 14, wherein the first response is different in an instance in which the account knowledge level for the account is the first account knowledge level than in an instance in which the account knowledge level for the account is the second account knowledge level.
Clause 16. The system of Clause 10, wherein the at least one processing device is further configured to assign a base account knowledge level for the account in an instance the first query has not been received.
Clause 17. The system of Clause 16, wherein determining the account knowledge level for the account based on at least one of the one or more words of the first query comprises updating the base account knowledge level based on the at least one of the one or more words of the first query.
Clause 18. The system of Clause 10, wherein the at least one processing device is further configured to cause the first response to be provided to the computing device associated with the account.
Clause 19. A computer program product for providing personalized security information based on prompt responses, the computer program product comprising at least one non-transitory computer-readable medium having one or more computer-readable program code portions embodied therein, the one or more computer-readable program code portions comprising at least one executable portion configured to: receive a first query from a computing device associated with an account, wherein the first query comprises one or more words that are related to the account; determine an account knowledge level for the account based on at least one of the one or more words of the first query, wherein the account knowledge level indicates a sophistication of the account; and determine a first response to the first query based on the account knowledge level associated with the account, wherein a response complexity level of one or more words used in the first response are based on the account knowledge level.
Clause 20. The computer program product of Clause 19, wherein the one or more computer-readable program code portions comprise at least one executable portion further configured to: receive an account history indicator, wherein the account history indicator comprises one or more pages accessed by the account; and update the account knowledge level based on the account history indicator.
Clause 21. The computer program product of Clause 20, wherein each of the one or more pages are assigned a complexity level, wherein a higher complexity level indicates that the account knowledge level is higher.
Clause 22. The computer program product of Clause 19, wherein the one or more computer-readable program code portions comprise at least one executable portion further configured to update the account knowledge level for the account based on a second query.
Clause 23. The computer program product of Clause 19, wherein the account knowledge level is determined to be one of a plurality of account knowledge levels, wherein a first account knowledge level is higher than a second account knowledge level.
Clause 24. The computer program product of Clause 23, wherein the first response is different in an instance in which the account knowledge level for the account is the first account knowledge level than in an instance in which the account knowledge level for the account is the second account knowledge level.
Clause 25. The computer program product of Clause 19, wherein the one or more computer-readable program code portions comprise at least one executable portion further configured to assign a base account knowledge level for the account in an instance the first query has not been received.
Clause 26. The computer program product of Clause 25, wherein determining the account knowledge level for the account based on at least one of the one or more words of the first query comprises updating the base account knowledge level based on the at least one of the one or more words of the first query.
Clause 27. The computer program product of Clause 19, wherein the one or more computer-readable program code portions comprise at least one executable portion further configured to cause the first response to be provided to the computing device associated with the account.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A method for providing personalized security information based on prompt responses, the method comprising:
receiving a first query from a computing device associated with an account, wherein the first query comprises one or more words that are related to the account;
determining an account knowledge level for the account based on at least one of the one or more words of the first query, wherein the account knowledge level indicates a sophistication of the account; and
determining a first response to the first query based on the account knowledge level associated with the account, wherein a response complexity level of one or more words used in the first response are based on the account knowledge level.

2. The method of claim 1, further comprising:
receiving an account history indicator, wherein the account history indicator comprises one or more pages accessed by the account; and
updating the account knowledge level based on the account history indicator.

3. The method of claim 2, wherein each of the one or more pages are assigned a complexity level, wherein a higher complexity level indicates that the account knowledge level is higher.

4. The method of claim 1, further comprising updating the account knowledge level for the account based on a second query.

5. The method of claim 1, wherein the account knowledge level is determined to be one of a plurality of account knowledge levels, wherein a first account knowledge level is higher than a second account knowledge level.

6. The method of claim 5, wherein the first response is different in an instance in which the account knowledge level for the account is the first account knowledge level than in an instance in which the account knowledge level for the account is the second account knowledge level.

7. The method of claim 1, further comprising assigning a base account knowledge level for the account in an instance the first query has not been received.

8. The method of claim 7, wherein determining the account knowledge level for the account based on at least one of the one or more words of the first query comprises updating the base account knowledge level based on the at least one of the one or more words of the first query.

9. The method of claim 1, further comprising causing the first response to be provided to the computing device associated with the account.

10. A system for providing personalized security information based on prompt responses, the system comprising:
at least one non-transitory storage device; and
at least one processing device coupled to the at least one non-transitory storage device, wherein the at least one processing device is configured to:
receive a first query from a computing device associated with an account, wherein the first query comprises one or more words that are related to the account;
determine an account knowledge level for the account based on at least one of the one or more words of the first query, wherein the account knowledge level indicates a sophistication of the account; and
determine a first response to the first query based on the account knowledge level associated with the account, wherein a response complexity level of one or more words used in the first response are based on the account knowledge level.

11. The system of claim 10, wherein the at least one processing device is further configured to:
receive an account history indicator, wherein the account history indicator comprises one or more pages accessed by the account; and
update the account knowledge level based on the account history indicator.

12. The system of claim 11, wherein each of the one or more pages are assigned a complexity level, wherein a higher complexity level indicates that the account knowledge level is higher.

13. The system of claim 10, wherein the at least one processing device is further configured to update the account knowledge level for the account based on a second query.

14. The system of claim 10, wherein the account knowledge level is determined to be one of a plurality of account knowledge levels, wherein a first account knowledge level is higher than a second account knowledge level.

15. The system of claim 14, wherein the first response is different in an instance in which the account knowledge level for the account is the first account knowledge level than in an instance in which the account knowledge level for the account is the second account knowledge level.

16. A computer program product for providing personalized security information based on prompt responses, the computer program product comprising at least one non-transitory computer-readable medium having one or more computer-readable program code portions embodied therein, the one or more computer-readable program code portions comprising at least one executable portion configured to:
receive a first query from a computing device associated with an account, wherein the first query comprises one or more words that are related to the account;
determine an account knowledge level for the account based on at least one of the one or more words of the first query, wherein the account knowledge level indicates a sophistication of the account; and
determine a first response to the first query based on the account knowledge level associated with the account, wherein a response complexity level of one or more words used in the first response are based on the account knowledge level.

17. The computer program product of claim 16, wherein the one or more computer-readable program code portions comprise at least one executable portion further configured to:
receive an account history indicator, wherein the account history indicator comprises one or more pages accessed by the account; and
update the account knowledge level based on the account history indicator.

18. The computer program product of claim 17, wherein each of the one or more pages are assigned a complexity level, wherein a higher complexity level indicates that the account knowledge level is higher.

19. The computer program product of claim 16, wherein the one or more computer-readable program code portions comprise at least one executable portion further configured to update the account knowledge level for the account based on a second query.

20. The computer program product of claim 16, wherein the account knowledge level is determined to be one of a plurality of account knowledge levels, wherein a first account knowledge level is higher than a second account knowledge level, wherein the first response is different in an instance in which the account knowledge level for the account is the first account knowledge level than in an instance in which the account knowledge level for the account is the second account knowledge level.
